(19) United States
(12) Patent Application Publication
(10) Pub. No.: US 2014/0182680 A1
(43) Pub. Date: Jul. 3, 2014

(54) ELECTROLYTE FORMULATIONS

(71) Applicant: Merck Patent GmbH, Darmstadt (DE)

(72) Inventors: Kentaro KAWATA, Ebina, Kanagawa (JP); Tomohisa GOTO, Sagamihara (JP); Nikolai (Mykola) IGNATYEV, Duisburg (DE); Michael SCHULTE, Bischofsheim (DE); Hiroki YOSHIZAKI, Mitaka, Tokyo (JP); Eduard BERNHARDT, Wuppertal (DE); Vera BERNHARDT-PITCHOUGINA, Wuppertal (DE); Helge WILLNER, Muehlheim/Ruhr (DE)

(73) Assignee: MERCK PATENT GMBH, Darmstadt (DE)

(21) Appl. No.: 14/122,410

(22) PCT Filed: May 23, 2012
(86) PCT No.: PCT/EP12/02180

§ 371 Date: Nov. 26, 2013

(30) Foreign Application Priority Data
May 31, 2011 (EP) 11004433.6

(51) Int. Cl. H01G 9/20

(52) U.S. Cl. CPC H01G 9/2013
USPC 136/263; 548/110; 568/6; 252/62.2

(57) ABSTRACT

The present invention relates to electrolyte formulations comprising at least one compound comprising a dihydridodicyanoborate anion and their use in an eletrochemical and/or optoelectronic device such as a photovoltaic cell, a light emitting device, an electrochromic or photo-electrochromic device, an electrochemical sensor and/or biosensor, preferably their use in a dye or quantum dot sensitized solar cell.

The present invention relates to electrolyte formulations comprising at least one compound comprising a dihydridodicyanoborate anion and their use in an electrochemical and/or optoelectronic device such as a photovoltaic cell, a light emitting device, an electrochromic or photo-electrochromic device, an electrochemical sensor and/or biosensor, preferably their use in a dye or quantum dot sensitized solar cell.

Electrolyte formulations form a crucial part of electrochemical and/or optoelectronic devices and the performance of the device largely depends on the physical and chemical properties of the various components of these electrolytes.

The term electrolytes is used herein in the sense of electrolyte formulation as defined below and will be used equally to electrolyte formulation within the disclosure.

Factors which are still impeding the technical application of many electrochemical and/or optoelectronic devices and in particular of dye or quantum dot sensitized solar cells, are reliability problems caused by the volatility of organic solvents based electrolytes. It is very difficult to maintain a tight sealing of the electrolyte in e.g. a DSC panel, which has to withstand the temperature differences of daily day-night cycles and the concomitant thermal expansion of the electrolyte. The abbreviation DSC means dye sensitized solar cell. This problem can be solved in principle by the use of ionic liquid-based electrolytes. For review “Ionic liquid electrolytes for dye-sensitized solar cells” see: William R Pitner et al., “Application of Ionic Liquids in Electrolyte System” Green Chemistry. vol. 6, (2010). Ionic liquids or liquid salts are typically ionic species which consist of an organic cation and a generally inorganic anion usually having melting points below 373 K. Various binary ionic liquid electrolytes have recently been applied to dye-sensitized solar cells. WO 2007/093961 and WO 2009/083901 describe so far the best power conversion efficiencies in ionic liquid-based electrolytes for DSC containing a significant quantity of organic salts with tetracyanoborate (TCB) anions.

However, there continues to be a demand for new and improved electrolytes based on ionic liquids with improved properties providing better or equal DSC efficiency.

The object of the invention is therefore to provide electrolyte formulations for electrochemical and/or optoelectronic devices with improved properties such as exemplary power conversion efficiency in a broad temperature range (between −20° C. to 85° C.) such as a photovoltaic cell, a light emitting device, an electrochromic or photo-electrochromic device, an electrochemical sensor and/or biosensor, especially for dye or quantum dot sensitized solar cells, especially preferably for dye sensitized solar cells.

Surprisingly it was found that electrolyte formulations comprising dihydridodicyanoborate anions fulfil such demands.

It is believed that formulations comprising dihydridodicyanoborate anions reduce the Nernst diffusion resistance of redox-couple species (e.g. I⁻ and I₃⁻) and support the fast kinetic of redox reaction between dye in oxidised state and reductant.

The present invention therefore relates firstly to an electrolyte formulation comprising at least one compound comprising a dihydridodicyanoborate anion.

There are no restrictions per se regarding the choice of cation of the compound comprising a dihydridodicyanoborate anion in accordance with the present invention. Thus, the cation can be an inorganic or organic cation. Compounds with alkalimetal cations are preferred starting materials for the synthesis of compounds having organic cations or metal cations other than the alkalimetal cation in the starting material used for the synthesis.

The present invention furthermore relates to an electrolyte formulation comprising at least one compound of formula (I)

Kt^{z+}z[BH₂(CN)₂]⁻ (I)

in which
z denotes 1, 2, 3 or 4 and
Kt^{z+} denotes an inorganic cation or an organic cation selected from the group of
an oxonium cation of formula (1) or a sulfonium cation of formula (2)

[(R^{o})₃O]⁺ (1)

[(R^{o})₃S]⁺ (2),

where R^{o} each independently of one another denotes a straight-chain or branched alkyl group having 1-8 C atoms, non-substituted phenyl or phenyl which is substituted by R^{1*}, OR′, N(R′)₂, CN or halogen and in case of sulfonium cations of formula (2) additionally denotes each independently (R′″)₂N— and R′ is independently of each other H, non-fluorinated, partially fluorinated or perfluorinated straight-chain or branched C₁- to C₁₈-alkyl, saturated C₃- to C₇-cycloalkyl, non-substituted or substituted phenyl, R1* is independently of each other non-fluorinated, partially fluorinated or perfluorinated straight-chain or branched C₁- to C₁₈-alkyl, saturated C₃- to C₇-cycloalkyl, non-substituted or substituted phenyl and R′″ is independently of each other straight-chain or branched C₁ to C₆ alkyl; an ammonium cation, which conforms to the formula (3)

[NR₄]⁺ (3),

where
R in each case, independently of one another, denotes
   H, OR′, N(R′)₂, with the proviso that a maximum of one R in formula (3) is OR′ or N(R′)₂,
   straight-chain or branched alkyl having 1-20 C atoms,
   straight-chain or branched alkenyl having 2-20 C atoms and one or more double bonds,
   straight-chain or branched alkynyl having 2-20 C atoms and one or more triple bonds,
   saturated, partially or fully unsaturated cycloalkyl having 3-7 C atoms, which may be substituted by straight-chain or branched alkyl groups having 1-6 C atoms, where one or two R may be fully substituted by halogens, in particular —F and/or —Cl, and one or more of the substituents R may be partially substituted by halogens, in particular —F and/or —Cl, and/or by —OH, —OR′, —CN, —N(R′)₂, —C(O)OH, —C(O)OR′, —C(O)R′, —C(O)N(R′)₂, —SO₂N(R′)₂, —C(O)X, —SO₂OH, —SO₂X, —NO₂, —SR′, —S(O)R′, —SO₂R′ and where one or two non-adjacent carbon atoms in R which are not in the α-position may be replaced by atoms and/or atom groups selected from the group —O—, —S—, —S(O)—, —SO₂—, —SO₂O—, —C(O)—, —C(O)O—, —N⁺(R′)₂—, —P(O)R′O—, —C(O)NR′—, —SO₂NR′—, —OP(O)R′O—, —P(O)(N(R′)₂)NR′—, —P(F)₂═N— or —P(O)R′— where R′ each independently is H, non-fluorinated, partially fluorinated or perfluorinated straight-chain or branched C₁- to C₁₈-alkyl, saturated C₃- to C₇-cycloalkyl, non-substituted or substituted phenyl and X each independently is halogen;
a phosphonium cation, which conforms to the formula (4)

[P(R²)₄]⁺ (4),

where
R² in each case, independently of one another, denotes
   H, OR′ or N(R′)₂,
   straight-chain or branched alkyl having 1-20 C atoms,
   straight-chain or branched alkenyl having 2-20 C atoms and one or more double bonds,
   straight-chain or branched alkynyl having 2-20 C atoms and one or more triple bonds,
   saturated, partially or fully unsaturated cycloalkyl having 3-7 C atoms, which may be substituted by straight-chain or branched alkyl groups having 1-6 C atoms,
   where one or two R² may be fully substituted by halogens, in particular —F and/or —Cl, and one or more of the substituents R² may be partially substituted by halogens, in particular —F and/or —Cl, and/or by —OH, —OR′, —CN, —N(R′)₂, —C(O)OH, —C(O)OR′, —C(O)R′, —C(O)N(R′)₂, —SO₂N(R′)₂, —C(O)X, —SO₂OH, —SO₂X, —NO₂, —SR′, —S(O)R′, —SO₂R′ and where one or two non-adjacent carbon atoms in R² which are not in the α-position may be replaced by atoms and/or atom groups selected from the group —O—, —S—, —S(O)—, —SO₂—, —SO₂O—, —C(O)—, —C(O)O—, —N⁺(R′)₂—, —P(O)R′O—, —C(O)NR′—, —SO₂NR′—, —OP(O)R′O—, —P(O)(N(R′)₂)NR′—, —P(F)₂═N— or —P(O)R′— where R′ each independently is H, non-fluorinated, partially fluorinated or perfluorinated straight-chain or branched C₁- to C₁₈-alkyl, saturated C₃- to C₇-cycloalkyl, non-substituted or substituted phenyl and X each independently is halogen;
a uronium cation, which conforms to the formula (5)

[C(NR³R⁴)(OR⁵)(NR⁶R⁷)]⁺ (5),

where
R³ to R⁷ each, independently of one another, denote
   H, where H is excluded for R⁵,
   straight-chain or branched alkyl having 1 to 20 C atoms,
   straight-chain or branched alkenyl having 2-20 C atoms and one or more double bonds,
   straight-chain or branched alkynyl having 2-20 C atoms and one or more triple bonds,
   saturated, partially or fully unsaturated cycloalkyl having 3-7 C atoms, which may be substituted by straight-chain or branched alkyl groups having 1-6 C atoms, where one or two of the substituents R³ to R⁷ may be fully substituted by halogens, in particular —F and/or —Cl, and one or more of the substituents R³ to R⁷ may be partially substituted by halogens, in particular —F and/or —Cl, and/or by —OH, —OR′, —N(R′)₂, —CN, —C(O)OH, —C(O)OR′, —C(O)R′, —C(O)N(R′)₂, —SO₂N(R′)₂, —C(O)X, —SO₂OH, —SO₂X, —SR′, —S(O)R′, —SO₂R′, —NO₂ and where one or two non-adjacent carbon atoms in R³ to R⁷ which are not in the α-position may be replaced by atoms and/or atom groups selected from the group —O—, —S—, —S(O)—, —SO₂—, —SO₂O—, —C(O)—, —C(O)O—, —N⁺(R′)₂—, —P(O)R′O—, —C(O)NR′—, —SO₂NR′—, —OP(O)R′O—, —P(O)(N(R′)₂)NR′—, —P(F)₂═N— or —P(O)R′— where R′ each independently is H, non-fluorinated, partially fluorinated or perfluorinated straight-chain or branched C₁- to C₁₈-alkyl, saturated C₃- to C₇-cycloalkyl, non-substituted or substituted phenyl and X each independently is halogen;
a thiouronium cation, which conforms to the formula (6)

[C(NR³R⁴)(SR⁵)(NR⁶R⁷)]⁺ (6),

where
R³ to R⁷ each, independently of one another, denote
   H, where H is excluded for R⁵,
   straight-chain or branched alkyl having 1 to 20 C atoms,
   straight-chain or branched alkenyl having 2-20 C atoms and one or more double bonds,
   straight-chain or branched alkynyl having 2-20 C atoms and one or more triple bonds,
   saturated, partially or fully unsaturated cycloalkyl having 3-7 C atoms, which may be substituted by straight-chain or branched alkyl groups having 1-6 C atoms, where one or two of the substituents R³ to R⁷ may be fully substituted by halogens, in particular —F and/or —Cl, and one or more of the substituents R³ to R⁷ may be partially substituted by halogens, in particular —F and/or —Cl, and/or by —OH, —OR′, —N(R′)₂, —CN, —C(O)OH, —C(O)OR′, —C(O)R′, —C(O)N(R′)₂, —SO₂N(R′)₂, —C(O)X, —SO₂OH, —SO₂X, —SR′, —S(O)R′, —SO₂R′, —NO₂ and where one or two non-adjacent carbon atoms in R³ to R⁷ which are not in the α-position may be replaced by atoms and/or atom groups selected from the group —O—, —S—, —S(O)—, —SO₂—, —SO₂O—, —C(O)—, —C(O)O—, —N⁺(R′)₂—, —P(O)R′O—, —C(O)NR′—, —SO₂NR′—, —OP(O)R′O—, —P(O)(N(R′)₂)NR′—, —P(F)₂═N— or —P(O)R′— where R′ each independently is H, non-fluorinated, partially fluorinated or perfluorinated straight-chain or branched C₁- to C₁₈-alkyl, saturated C₃- to C₇-cycloalkyl, non-substituted or substituted phenyl and X each independently is halogen;
a guanidinium cation, which conforms to the formula (7)

[C(NR⁸R⁹)(NR¹⁰R¹¹)(NR¹²R¹³)]⁺ (7),

where
R⁸ to R¹³ each, independently of one another, denote
   H, —CN, N(R′)₂, —OR′,
   straight-chain or branched alkyl having 1 to 20 C atoms,
   straight-chain or branched alkenyl having 2-20 C atoms and one or more double bonds,
   straight-chain or branched alkynyl having 2-20 C atoms and one or more triple bonds,
   saturated, partially or fully unsaturated cycloalkyl having 3-7 C atoms, which may be substituted by straight-chain or branched alkyl groups having 1-6 C atoms, where one or two of the substituents R⁸ to R¹³ may be fully substituted by halogens, in particular —F and/or —Cl, and one or more of the substituents R⁸ to R¹³ may be partially substituted by halogens, in particular —F and/or —Cl, and/or by —OH, —OR′, —N(R′)₂, —CN, —C(O)OH, —C(O)OR′, —C(O)R′, —C(O)N(R′)₂, —SO₂N(R′)₂, —C(O)X, —SO₂OH, —SO₂X, —SR′, —S(O)R′, —SO₂R′, —NO₂ and where one or two non-adjacent carbon atoms in R⁸ to R¹³ which are not in the α-position may be replaced by atoms and/or atom groups selected from the group —O—, —S—, —S(O)—, —SO₂—, —SO₂O—, —C(O)—, —C(O)O—, —N⁺(R′)₂—, —P(O)R′O—, —C(O)NR′—, —SO₂NR′—, —OP(O)R′O—, —P(O)(N(R′)₂)NR′—, —P(F)₂═N— or —P(O)R′—, where R′ each independently is H, non-fluorinated, partially fluorinated or perfluorinated straight-chain or branched C₁- to C₁₈-alkyl, saturated C₃- to C₇-cycloalkyl, non-substituted or substituted phenyl and X each independently is halogen;
a heterocyclic cation which conforms to the formula (8)

[HetN]^{z+} (8)

where
HetN^{z+} denotes a heterocyclic cation selected from the group

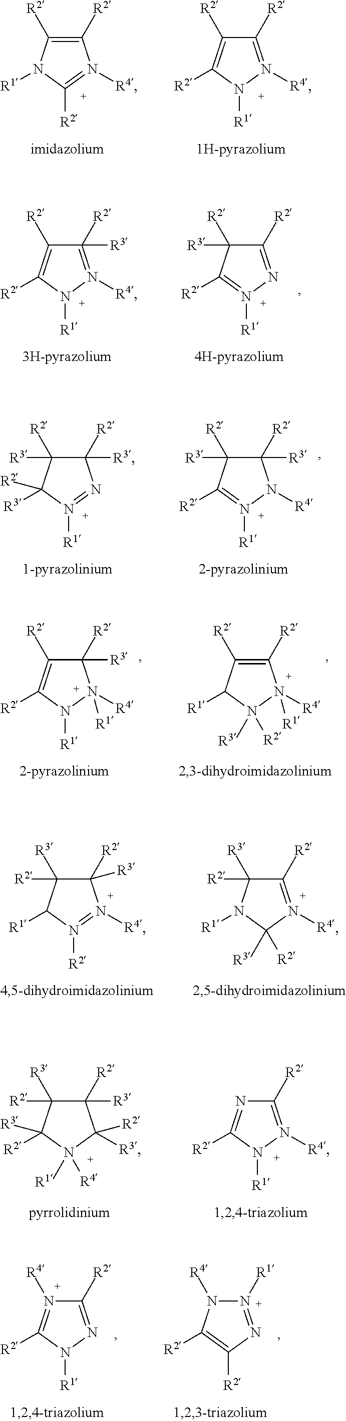

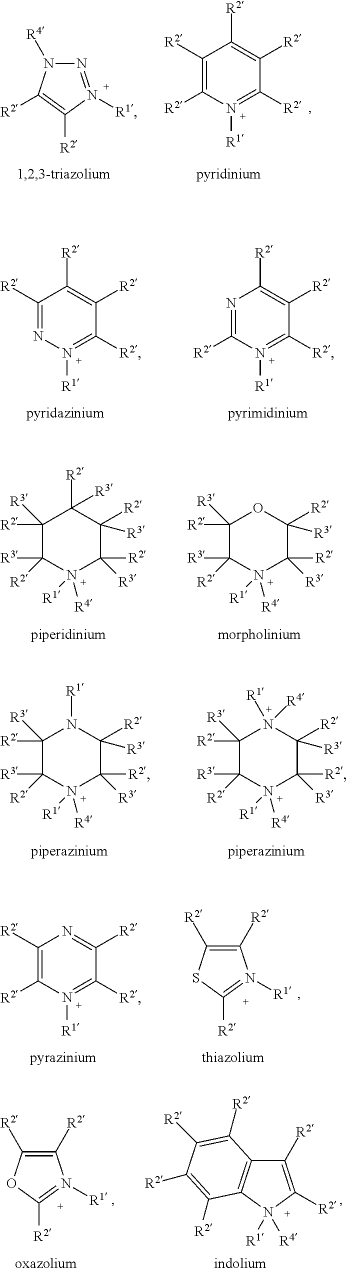

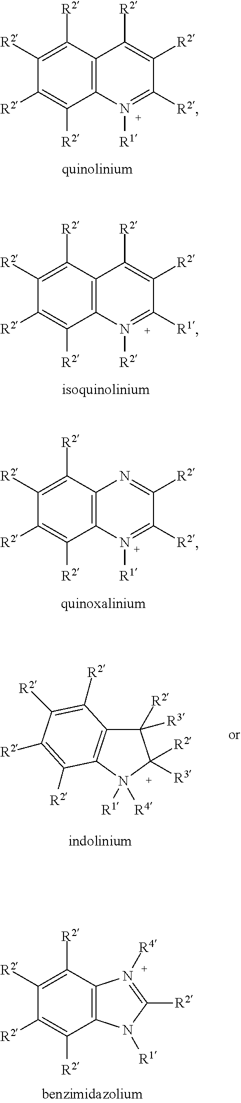

where the substituents
R^{1′} to R^{4′} each, independently of one another, denote H, with the proviso that R^{1′} and R^{4′} together are not H in one cation,
straight-chain or branched alkyl having 1-20 C atoms,
straight-chain or branched alkenyl having 2-20 C atoms and one or more double bonds,
straight-chain or branched alkynyl having 2-20 C atoms and one or more triple bonds,
saturated, partially or fully unsaturated cycloalkyl having 3-7 C atoms, which may be substituted by straight-chain or branched alkyl groups having 1-6 C atoms,
saturated, partially or fully unsaturated heteroaryl, heteroaryl-C₁-C₆-alkyl or aryl-C₁-C₆-alkyl and
R^{2′} denote additionally F, Cl, Br, I, —CN, —OR′, —N(R′)₂, —P(O)(R′)₂, —P(O)(OR′)₂, —P(O)(N(R′)₂)₂, —C(O)R′, —C(O)OR′, —C(O)X, —C(O)N(R′)₂, —SO₂N(F)₂, —SO₂OH, —SO₂X, —SR′, —S(O)R′, —SO₂R′ and/or NO₂, with the proviso that R^{1′}, R^{3′}, R^{4′} are in this case independently of each other H and/or a straight-chain or branched alkyl having 1-20 C atoms, straight-chain or branched alkenyl having 2-20 C atoms and one or more double bonds,
where the substituents R^{1′}, R^{2′}, R^{3′} and/or R^{4′} together may also form a ring system,
where one to three substituents R^{1′} to R^{4′} may be fully substituted by halogens, in particular —F and/or —Cl, and one or more substituents R^{1′} to R^{4′} may be partially substituted by halogens, in particular —F and/or —Cl, and/or by —OH, —OR′, N(R′)₂, —CN, —C(O)OH, —C(O)OR′, —C(O)R′, —C(O)N(R′)₂, —SO₂N(R′)₂, —C(O)X, —SO₂OH, —SO₂X, —SR′, —S(O)R′, —SO₂R′, —NO₂, but where R^{1′} and R^{4′} cannot simultaneously be fully substituted by halogens and where, in the substituents R^{1′} to R^{4′}, one or two non-adjacent carbon atoms which are not bonded to the heteroatom may be replaced by atoms and/or atom groups selected from the —O—, —S—, —S(O)—, —SO₂—, —SO₂O—, —C(O)—, —C(O)O—, —N⁺(R′)₂—, —P(O)R′O—, —C(O)NR′—, —SO₂NR′—, —OP(O)R′O—, —P(O)(N(R′)₂)NR′—, —P(F)₂═N— or —P(O)R′—,
where R′ each independently is H, non-fluorinated, partially fluorinated or perfluorinated straight-chain or branched C₁- to C₁₈-alkyl, saturated C₃- to C₇-cycloalkyl, non-substituted or substituted phenyl and X each independently is halogen
and halogen is F, Cl, Br or I.

Examples of organic cations are also polyammonium ions having a degree of charging z=4 or tritylium cation in which the phenyl groups may be substituted by straight-chain or branched alkyl groups having 1 to 20 C atoms, straight-chain or branched alkenyl having 2 to 20 C atoms and one or more double bonds or straight-chain or branched alkynyl having 2 to 20 C atoms and one or more triple bonds.

The electrolyte formulations may include or comprise, essentially consist of or consist of the said necessary or optional constituents as described above and below.

Compounds of formula (I) with organic cations such as N,N-dimethyl-N-butyl-hydrazinium, N,N-dimethyl-N-allyl-hydrazinium, 3-allyl-1-methylimidazolium, N-butylpyridinium, N-allylpyridinium, N-butyl-N-methyl-pyrrolidinium, N-allyl-N-methylpyrrolidinium, 1-butyl-3-methyltriazolium or 1-allyl-3-methyltriazolium cations are known from Zhang Y. and Shreeve J. M., Angew. Chem. 2011, vol. 123, p. 965-967. However this citation does not describe an electrolyte formulation comprising compounds of formula (I) as described above and it does not disclose the specific utility of these compounds as components of an electrolyte formulation for the given electrochemical and/or electrooptical devices, especially for DSC. The above mentioned organic salts are synthesized via anion exchange-reaction with Ag[BH₂(CN)₂].

Further compounds of formula (I) with organic or inorganic cations are known e.g. from Spielvogel B. F. et al, Inorg. Chem. 1984, 23, 3262-3265, Das M. K. et al, Bull. Chem. Soc. Jpn., 63, 1281-1283, 1990 and B. Gyori et al, Journal of Organometallic Chemistry, 255, 1983, 17-28.

The cation [Kt]^{z+} may in addition also be inorganic, in particular a metal cation or NO⁺. The metal cation may comprise metals from groups 1 to 12 of the Periodic Table.

Preferred metal cations are alkali metal cations, such as Li⁺, Na⁺, K⁺, Rb⁺, Cs⁺, or Mg²⁺, Cu⁺, Cu²⁺, Zn²⁺, Ca²⁺, Y⁺³, Yb⁺³, La⁺³, Sc⁺³, Ce⁺³, Nd⁺³, Tb⁺³, Sm⁺³ or complex (ligands containing) metal cations which include rare-earths, transitions or noble metals like rhodium, ruthenium, iridium, palladium, platinum, osmium, cobalt, nickel, iron, chromium, molybdenum, tungsten, vanadium, titanium, zirconium, hafnium, thorium, uranium, gold. The alkali metal is preferably lithium, sodium or potassium. The cation [Kt]^{z+} is preferably an organic cation and z is preferably 1 or 2, particular preferably 1.

R^{o} of the [(R^{o})₃O]⁺cation or [(R^{o})₃S]⁺ cation is preferably straight-chain alkyl having 1-8 C atoms, preferably having 1-4 C atoms, in particular methyl or ethyl, very particularly preferably ethyl. A particularly preferred sulfonium cation is diethyl-methylsulfonium or triethylsulfonium.

For the purposes of the present invention, fully unsaturated cycloalkyl substituents are also taken to mean aromatic substituents.

In accordance with the invention, suitable substituents R and R² to R¹³ of the compounds of the formulae (3) to (7) are preferably: H, C₁- to C₂₀-, in particular C₁- to C₁₄-alkyl groups, and saturated or unsaturated, i.e. also aromatic, C₃- to C₇-cycloalkyl groups, which may be substituted by C₁- to C₆-alkyl groups, in particular phenyl which may be substituted by C₁- to C₆-alkyl groups.

The substituents R and R² in the compounds of the formula (3) or (4) may be identical or different. The substituents R and R² are preferably different.

The substituents R and R² are particularly preferably methyl, ethyl, iso-propyl, propyl, butyl, sec-butyl, pentyl, hexyl, octyl, decyl or tetradecyl.

Up to four substituents of the guanidinium cation [C(NR⁸R⁹)(NR¹⁰R¹¹)(NR¹²R¹³)]⁺ may also be bonded in pairs in such a way that mono-, bi- or polycyclic cations are formed.

Without restricting generality, examples of such guanidinium cations are:

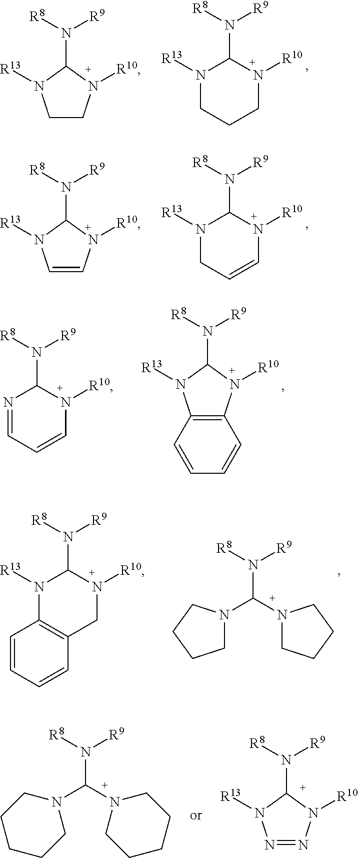

where the substituents R⁸ to R¹⁰ and R¹³ can have a meaning or particularly preferred meaning indicated above.

If desired, the carbocycles or heterocycles of the guanidinium cations indicated above may also be substituted by straight-chain or branched C₁- to C₆-alkyl, straight-chain or branched C₁- to C₆-alkenyl, —CN, —NO₂, F, Cl, Br, I, OH, straight-chain or branched C₁-C₆-alkoxy, —N(R′)₂, —SR′, —S(O)R′, —SO₂R′, —COOH, —C(O)OR′, —C(O)R′, —C(O)N(R′)₂, —SO₂N(R′)₂, —C(O)X, —SO₂X, —SO₃H, substituted or non-substituted phenyl or a non-substituted or substituted heterocycle, where X and R′ have a meaning indicated above.

Up to four substituents of the uronium cation [C(NR³R⁴)(OR⁵)(NR⁶R⁷)]⁺ or thiouronium cation [C(NR³R⁴)(SR⁵)(NR⁶R⁷)]⁺ may also be bonded in pairs in such a way that mono-, bi- or polycyclic cations are formed.

Without restricting generality, examples of such cations are indicated below, where Y═O or S:

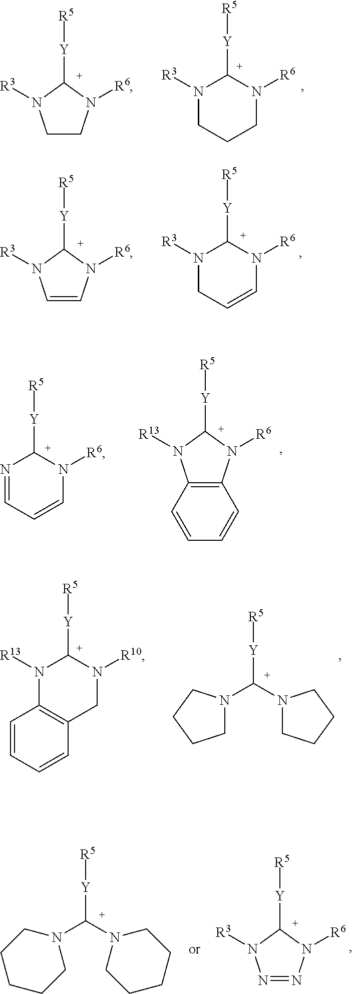

where the substituents R³, R⁵ and R⁶ can have a meaning or particularly preferred meaning indicated above.

If desired, the carbocycles or heterocycles of the cations indicated above may also be substituted by straight-chain or branched C₁- to C₆-alkyl, straight-chain or branched C₁- to C₆-alkenyl, —CN, —NO₂, F, Cl, Br, I, OH, straight-chain or branched C₁-C₆-alkoxy, —N(R′)₂, —SR′, —S(O)R′, —SO₂R′, —COOH, —C(O)OR′, —C(O)R′, —C(O)N(R′)₂, —SO₂N(R′)₂, —C(O)X, —SO₂X, —SO₃H, substituted or non-substituted phenyl or a non-substituted or substituted heterocycle, where X and R′ have a meaning indicated above.

The substituents R³ to R¹³ are each, independently of one another, preferably a straight-chain or branched alkyl group having 1 to 16 C atoms. The substituents R³ and R⁴, R⁶ and R⁷, R⁸ and R⁹, R¹⁰ and R¹¹ and R¹² and R¹³ in compounds of the formulae (5) to (7) may be identical or different. R³ to R¹³ are particularly preferably each, independently of one another, methyl, ethyl, n-propyl, iso-propyl, n-butyl, tert-butyl, sec-butyl, phenyl, hexyl or cyclohexyl, very particularly preferably methyl, ethyl, n-propyl, iso-propyl, n-butyl or n-hexyl.

In accordance with the invention, suitable substituents R^{1′} to R^{4′} of compounds of the formula (8) are each, independently of one another, preferably,

H, with the proviso that R^{1′} and R^{4′} together are not H in one cation,
straight-chain or branched alkyl having 1 to 20 C atoms, which optionally may be fluorinated or perfluorinated,
straight-chain or branched alkenyl having 2 to 20 C atoms and one or more double bonds, which optionally may be fluorinated,
straight-chain or branched alkynyl having 2 to 20 C atoms and one or more triple bonds which optionally may be fluorinated or
straight-chain or branched alkoxyalkyl having 2 to 8 C atoms, with the assumption that R^{1′} and R^{4′} are not simultaneously be perfluorinated.

The substituents R^{1′} and R^{4′} are each, independently of one another, particularly preferably straight-chain or branched alkyl having 1 to 20 C atoms, which optionally may be fluorinated or perfluorinated or straight-chain or branched alkoxyalkyl having 2 to 8 C atoms with the assumption that R^{1′} and R^{4′} are not perfluorinated at the same time.

The substituents R^{1′} and R^{4′} are each, independently of one another, particularly preferably methyl, ethyl, allyl, isopropyl, propyl, butyl, sec-butyl, tert-butyl, n-pentyl, n-hexyl, n-octyl, n-decyl, cyclohexyl, methoxyethyl, methoxymethyl, ethoxyethyl, ethoxymethyl, phenyl or benzyl. They are very particularly preferably methyl, ethyl, n-propyl, n-butyl or methoxyethyl. In pyrrolidinium, piperidinium or indolinium compounds, the two substituents R^{1′} and R^{4′} are preferably different.

In accordance with the invention, suitable substituents R^{2′} and R^{3′} of compounds of formula (8) are particularly preferably: H, straight-chain or branched C₁- to C₂₀-, in particular C₁- to C₁₂-alkyl groups, and saturated or unsaturated, i.e. also aromatic, C₃- to C₇-cycloalkyl groups, which may be substituted by straight-chain or branched C₁- to C₆-alkyl groups, in particular phenyl.

The substituent R^{2′} or R^{3′} is in each case, independently of one another, in particular H, methyl, ethyl, iso-propyl, n-propyl, n-butyl, sec-butyl, tert-butyl, cyclohexyl, phenyl or benzyl. R^{2′} is particularly preferably H, methyl, ethyl, iso-propyl, n-propyl, n-butyl or sec-butyl. R^{3′} is particularly preferably H. R^{2′} and R^{3′} are very particularly preferably H.

A straight-chain or branched alkyl having 1-20 C atoms denotes an alkyl group having 1, 2, 3, 4, 5, 6, 7, 8, 9, 10, 11, 12, 13, 14, 15, 16, 17, 18, 19 or 20 C atoms, for example methyl, ethyl, iso-propyl, n-propyl, sec-butyl, n-butyl, tert-butyl, n-pentyl, 1-, 2- or 3-methylbutyl, 1,1-, 1,2- or 2,2-dimethylpropyl, 1-ethylpropyl, n-hexyl, n-heptyl, n-octyl, ethylhexyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl or eicosyl, which optionally may be fluorinated or perfluorinated. The term “perfluorinated” means that all H atoms are substituted by F atoms in the given alkyl group. The term “fluorinated” means that at least one H atom of the given alkyl group is substituted by an F atom.

A straight-chain or branched alkenyl having 2 to 20 C atoms, in which a plurality of double bonds may also be present, is, for example, allyl, 2- or 3-butenyl, isobutenyl, sec-butenyl, furthermore 4-pentenyl, iso-pentenyl, hexenyl, heptenyl, octenyl, —C₉H₁₇, —C₁₀H₁₉ to —C₂₀H₃₉, preferably allyl, 2- or 3-butenyl, iso-butenyl, sec-butenyl, furthermore preferably 4-pentenyl, iso-pentenyl or hexenyl, which may be optionally partially fluorinated.

A straight-chain or branched alkynyl having 2 to 20 C atoms, in which a plurality of triple bonds may also be present, is, for example, ethynyl, 1- or 2-propynyl, 2- or 3-butynyl, furthermore 4-pentynyl, 3-pentynyl, hexynyl, heptynyl, octynyl, —C₉H₁₆, —C₁₀H₁₇ to —C₂₀H₃₇, preferably ethynyl, 1- or 2-propynyl, 2- or 3-butynyl, 4-pentynyl, 3-pentynyl or hexynyl, which may be optionally partially fluorinated.

A straight-chain or branched alkoxyalkyl having 2 to 12 C atoms is, for example, methoxymethyl, 1-methoxyethyl, 1-methoxypropyl, 1-methoxy-2-methyl-ethyl, 2-methoxy-propyl, 2-methoxy-2-methyl-propyl, 1-methoxybutyl, 1-methoxy-2,2-dimethyl-ethyl, 1-methoxy-pentyl, 1-methoxyhexyl, 1-methoxy-heptyl, ethoxymethyl, 1-ethoxyethyl, 1-ethoxypropyl, 1-ethoxy-2-methyl-ethyl, 1-ethoxybutyl, 1-ethoxy-2,2-dimethyl-ethyl, 1-ethoxypentyl, 1-ethoxyhexyl, 1-ethoxyheptyl, propoxymethyl, 1-propoxyethyl, 1-propoxypropyl, 1-propoxy-2-methyl-ethyl, 1-propoxybutyl, 1-propoxy-2,2-dimethyl-ethyl, 1-propoxypentyl, butoxymethyl, 1-butoxyethyl, 1-butoxypropyl or 1-butoxybutyl. Particularly preferred is methoxymethyl, 1-methoxyethyl, 2-methoxy-propyl, 1-methoxypropyl, 2-methoxy-2-methyl-propyl or 1-methoxybutyl.

Aryl-C₁-C₆-alkyl denotes, for example, benzyl, phenylethyl, phenylpropyl, phenylbutyl, phenylpentyl or phenylhexyl, where both the phenyl ring and also the alkylene chain may be partially or fully substituted, as described above, by halogens, in particular —F and/or —Cl, or partially by —OH, —OR′, —N(R′)₂, —CN, —C(O)OH, —C(O)N(R′)₂, —SO₂N(R′)₂, —C(O)X, —C(O)OR′, —C(O)R′, —SO₂OH, —SO₂X, —SR′, —S(O)R′, —SO₂R′, —NO₂ and R′ and X have a meaning as described above.

Non-substituted saturated or partially or fully unsaturated cycloalkyl groups having 3-7 C atoms are therefore cyclopropyl, cyclobutyl, cyclopentyl, cyclohexyl, cycloheptyl, cyclopentenyl, cyclopenta-1,3-dienyl, cyclohexenyl, cyclohexa-1,3-dienyl, cyclohexa-1,4-dienyl, phenyl, cycloheptenyl, cyclohepta-1,3-dienyl, cyclohepta-1,4-dienyl or cyclohepta-1,5-dienyl, each of which may be substituted by straight-chain or branched C₁- to C₆-alkyl groups, where the cycloalkyl group or the cycloalkyl group substituted by straight-chain or branched C₁- to C₆-alkyl groups may in turn also be substituted by halogen atoms, such as F, Cl, Br or I, in particular F or Cl, or by —OH, —OR′, —N(F)₂, —CN, —C(O)OH, —C(O)N(F)₂, —SO₂N(R′)₂, —C(O)X, —C(O)OR′, —C(O)R′, —SO₂OH, —SO₂X, —SR′, —S(O)R′, —SO₂R′, —NO₂ and R′ and X have a meaning as described above.

In the substituents R, R² to R¹³ or R^{1′} to R^{4′}, one or two non-adjacent carbon atoms which are not bonded in the α-position to the heteroatom may also be replaced by atoms and/or atom groups selected from the group —O—, —S—, —S(O)—, —SO₂—, —SO₂O—, —C(O)—, —C(O)O—, —N⁺ R′₂—, —P(O)R′O—, —C(O)NR′—, —SO₂NR′—, —OP(O)R′O—, —P(O)(NR′₂)NR′—, —PR′₂═N— or —P(O)R′—, where R′=non-fluorinated, partially fluorinated or perfluorinated C₁- to C₁₈-alkyl, saturated C₃- to C₇-cycloalkyl, non-substituted or substituted phenyl.

Without restricting generality, examples of substituents R, R² to R¹³ and R^{1′} to R^{4′} modified in this way are:

—OCH₃, —OCH(CH₃)₂, —CH₂OCH₃, —CH₂—CH₂—O—CH₃, —C₂H₄OCH(CH₃)₂, —C₂H₄SC₂H₅, —C₂H₄SCH(CH₃)₂, —S(O)CH₃, —SO₂CH₃, —SO₂C₆H₅, —SO₂C₃H₇, —SO₂CH(CH₃)₂, —SO₂CH₂CF₃, —CH₂SO₂CH₃, —O—C₄H₈—O—C₄H₉, —CF₃, —C₂F₅, —C₃F₇, —C₄F₉, —C(CF₃)₃, —CF₂SO₂CF₃, —C₂F₄N(C₂F₅)C₂F₅, —CHF₂, —CH₂CF₃, —C₂F₂H₃, —C₃FH₆, —CH₂C₃F₇, —C(CFH₂)₃, —CH₂C(O) OH, —CH₂C₆H₅, —C(O)C₆H₅ or P(O)(C₂H₅)₂.

In R′ or in R^{1*}, C₃- to C₇-cycloalkyl is, for example, cyclopropyl, cyclobutyl, cyclopentyl, cyclohexyl or cycloheptyl.

In R′ or in R^{1*}, substituted phenyl denotes phenyl which is substituted by straight-chain or branched C₁- to C₆-alkyl, straight-chain or branched C₁- to C₆-alkenyl, —CN, —NO₂, F, Cl, Br, I, —OH, straight-chain or branched-C₁-C₆-alkoxy, N(R″)₂, —COOH, —C(O)OR″, —C(O)R″, —SO₂X′, —SR″, —S(O)R″, —SO₂R″, SO₂N(R″)₂ or SO₃H, where X′ denotes F, CI or Br and R″ denotes a non-fluorinated, partially fluorinated or perfluorinated straight-chain or branched C₁- to C₆-alkyl or C₃- to C₇-cycloalkyl as defined for R′, for example o-, m- or p-methylphenyl, o-, m- or p-ethylphenyl, o-, m- or p-propylphenyl, o-, m- or p-isopropylphenyl, o-, m- or p-tert-butylphenyl, o-, m- or p-nitrophenyl, o-, m- or p-hydroxyphenyl, o-, m- or p-methoxyphenyl, o-, m- or p-ethoxyphenyl, o-, m-, p-(trifluoromethyl)phenyl, o-, m-, p-(trifluoromethoxy)phenyl, o-, m-, p-(trifluoromethylsulfonyl)phenyl, o-, m- or p-fluorophenyl, o-, m- or p-chlorophenyl, o-, m- or p-bromophenyl, o-, m- or p-iodophenyl, further preferably 2,3-, 2,4-, 2,5-, 2,6-, 3,4- or 3,5-dimethylphenyl, 2,3-, 2,4-, 2,5-, 2,6-, 3,4- or 3,5-dihydroxyphenyl, 2,3-, 2,4-, 2,5-, 2,6-, 3,4- or 3,5-difluorophenyl, 2,3-, 2,4-, 2,5-, 2,6-, 3,4- or 3,5-dichlorophenyl, 2,3-, 2,4-, 2,5-, 2,6-, 3,4- or 3,5-dibromophenyl, 2,3-, 2,4-, 2,5-, 2,6-, 3,4- or 3,5-dimethoxyphenyl, 5-fluoro-2-methylphenyl, 3,4,5-trimethoxyphenyl or 2,4,5-trimethylphenyl.

In R^{1′} to R^{4′}, heteroaryl is taken to mean a saturated or unsaturated mono- or bicyclic heterocyclic group having 5 to 13 ring members, in which 1, 2 or 3 N and/or 1 or 2 S or O atoms may be present and the heterocyclic radical may be mono- or poly-substituted by straight-chain or branched C₁- to C₆-alkyl, straight-chain or branched C₁- to C₆-alkenyl, —CN, —NO₂, F, Cl, Br, I, —OH, —N(R″)₂, straight-chain or branched C₁-C₆-alkoxy, —COOH, —C(O)OR″, —C(O)R″, —SO₂X′, —SO₂N(R″)₂, —SR″, —S(O)R″, —SO₂R″ or SO₃H, where X′ and R″ have a meaning indicated above.

The heterocyclic group is preferably substituted or non-substituted 2- or 3-furyl, 2- or 3-thienyl, 1-, 2- or 3-pyrrolyl, 1-, 2-, 4- or 5-imidazolyl, 3-, 4- or 5-pyrazolyl, 2-, 4- or 5-oxazolyl, 3-, 4- or 5-isoxazolyl, 2-, 4- or 5-thiazolyl, 3-, 4- or 5-isothiazolyl, 2-, 3- or 4-pyridyl, 2-, 4-, 5- or 6-pyrimidinyl, furthermore preferably 1,2,3-triazol-1-, -4- or -5-yl, 1,2,4-triazol-1-, -4- or -5-yl, 1- or 5-tetrazolyl, 1,2,3-oxadiazol-4- or -5-yl, 1,2,4-oxadiazol-3- or -5-yl, 1,3,4-thiadiazol-2- or -5-yl, 1,2,4-thiadiazol-3- or -5-yl, 1,2,3-thiadiazol-4- or -5-yl, 2-, 3-, 4-, 5- or 6-2H-thiopyranyl, 2-, 3- or 4-4H-thiopyranyl, 3- or 4-pyridazinyl, pyrazinyl, 2-, 3-, 4-, 5-, 6- or 7-benzofuryl, 2-, 3-, 4-, 5-, 6- or 7-benzothienyl, 1-, 2-, 3-, 4-, 5-, 6- or 7-1H-indolyl, 1-, 2-, 4- or 5-benzimidazolyl, 1-, 3-, 4-, 5-, 6- or 7-benzopyrazolyl, 2-, 4-, 5-, 6- or 7-benzoxazolyl, 3-, 4-, 5-, 6- or 7-benzisoxazolyl, 2-, 4-, 5-, 6- or 7-benzothiazolyl, 2-, 4-, 5-, 6- or 7-benzisothiazolyl, 4-, 5-, 6- or 7-benz-2,1,3-oxadiazolyl, 1-, 2-, 3-, 4-, 5-, 6-, 7- or 8-quinolinyl, 1-, 3-, 4-, 5-, 6-, 7- or 8-isoquinolinyl, 1-, 2-, 3-, 4- or 9-carbazolyl, 1-, 2-, 3-, 4-, 5-, 6-, 7-, 8- or 9-acridinyl, 3-, 4-, 5-, 6-, 7- or 8-cinnolinyl, 2-, 4-, 5-, 6-, 7- or 8-quinazolinyl or 1-, 2- or 3-pyrrolidinyl.

Heteroaryl-C₁-C₆-alkyl is, analogously to aryl-C₁-C₆-alkyl, taken to mean, for example, pyridinylmethyl, pyridinylethyl, pyridinylpropyl, pyridinylbutyl, pyridinylpentyl, pyridinylhexyl, where the heterocycles described above may furthermore be linked to the alkylene chain in this way.

HetN^{z+} is preferably

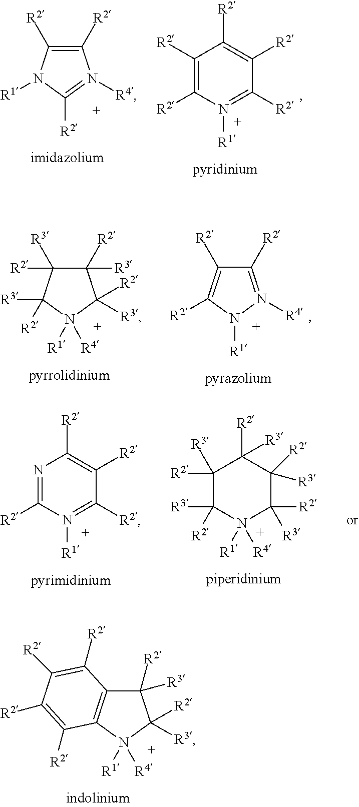

where the substituents R^{1′} to R^{4′} each, independently of one another, have a meaning described above.

HetN^{z+} is particularly preferably

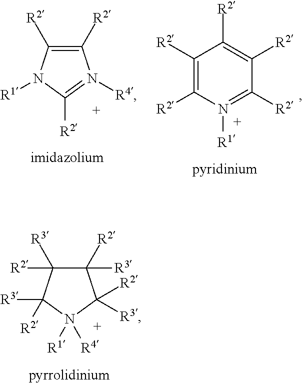

where the substituents R^{1′} to R^{4′} each, independently of one another, have a meaning described above.

HetN′ is very particularly preferably

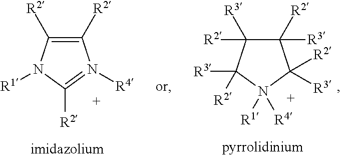

where the substituents R^{1′} to R^{4′} each, independently of one another, have a meaning described above. Preferred meanings of R^{1′} to R^{4′} within imidazolium or pyrrolidinium cations are defined in the following terms:

Preferred 1,1-dialkylpyrrolidinium cations are, for example, 1,1-dimethyl-pyrrolidinium, 1-methyl-1-ethylpyrrolidinium, 1-methyl-1-propylpyrrolidinium, 1-methyl-1-butylpyrrolidinium, 1-methyl-1-pentylpyrrolidinium, 1-methyl-1-hexylpyrrolidinium, 1-methyl-1-heptylpyrrolidinium, 1-methyl-1-octylpyrrolidinium, 1-methyl-1-nonylpyrrolidinium, 1-methyl-1-decylpyrrolidinium, 1,1-diethylpyrrolidinium, 1-ethyl-1-propylpyrrolidinium, 1-ethyl-1-butylpyrrolidinium, 1-ethyl-1-pentylpyrrolidinium, 1-ethyl-1-hexylpyrrolidinium, 1-ethyl-1-heptylpyrrolidinium, 1-ethyl-1-octylpyrrolidinium, 1-ethyl-1-nonylpyrrolidinium, 1-ethyl-1-decylpyrrolidinium, 1,1-dipropylpyrrolidinium, 1-propyl-1-methylpyrrolidinium, 1-propyl-1-butylpyrrolidinium, 1-propyl-1-pentylpyrrolidinium, 1-propyl-1-hexylpyrrolidinium, 1-propyl-1-heptylpyrrolidinium, 1-propyl-1-octylpyrrolidinium, 1-propyl-1-nonylpyrrolidinium, 1-propyl-1-decylpyrrolidinium, 1,1-dibutylpyrrolidinium, 1-butyl-1-methylpyrrolidinium, 1-butyl-1-pentylpyrrolidinium, 1-butyl-1-hexylpyrrolidinium, 1-butyl-1-heptylpyrrolidinium, 1-butyl-1-octylpyrrolidinium, 1-butyl-1-nonylpyrrolidinium, 1-butyl-1-decylpyrrolidinium, 1,1-dipentylpyrrolidinium, 1-pentyl-1-hexylpyrrolidinium, 1-pentyl-1-heptylpyrrolidinium, 1-pentyl-1-octylpyrrolidinium, 1-pentyl-1-nonylpyrrolidinium, 1-pentyl-1-decylpyrrolidinium, 1,1-dihexylpyrrolidinium, 1-hexyl-1-heptylpyrrolidinium, 1-hexyl-1-octylpyrrolidinium, 1-hexyl-1-nonylpyrrolidinium, 1-hexyl-1-decylpyrrolidinium, 1,1-dihexylpyrrolidinium, 1-hexyl-1-heptylpyrrolidinium, 1-hexyl-1-octylpyrrolidinium, 1-hexyl-1-nonylpyrrolidinium, 1-hexyl-1-decylpyrrolidinium, 1,1-diheptylpyrrolidinium, 1-heptyl-1-octylpyrrolidinium, 1-heptyl-1-nonylpyrrolidinium, 1-heptyl-1-decylpyrrolidinium, 1,1-dioctylpyrrolidinium, 1-octyl-1-nonyl-pyrrolidinium, 1-octyl-1-decylpyrrolidinium, 1,1-dinonylpyrrolidinium, 1-nonyl-1-decylpyrrolidinium or 1,1-didecylpyrrolidinium. Very particular preference is given to 1-butyl-1-methylpyrrolidinium or 1-propyl-1-methyl-pyrrolidinium.

Preferred 1-alkyl-1-alkoxyalkylpyrrolidinium cations are, for example, 1-methoxymethyl-1-methyl-pyrrolidinium, 1-methoxymethyl-1-ethyl-pyrrolidinium, 1-(2-methoxyethyl)-1-methylpyrrolidinium, 1-(2-methoxyethyl)-1-ethylpyrrolidinium, 1-(2-methoxyethyl)-1-propylpyrrolidinium, 1-(2-methoxyethyl)-1-butylpyrrolidinium, 1-(2-ethoxyethyl)-1-methylpyrrolidinium, 1-ethoxymethyl-1-methylpyrrolidinium, 1-ethoxymethyl-1-ethyl-pyrrolidinium. Very particular preference is given to 1-(2-methoxyethyl)-1-methylpyrrolidinium.

Preferred 1,3-dialkylimidazolium cations are, for example, 1-ethyl-3-methyl-imidazolium, 1-methyl-3-propylimidazolium, 1,2,3-trimethylimidazolium, 1-ethyl-2,3-dimethylimidazolium, 1-propyl-2,3-dimethylimidazolium, 1-butyl-2,3-dimethylimidazolium, 1-butyl-3-methylimidazolium, 1-methyl-3-pentylimidazolium, 1-ethyl-3-propylimidazolium, 1-butyl-3-ethylimidazolium, 1-ethyl-3-pentylimidazolium, 1-butyl-3-propylimidazolium, 1,3-dimethyl-imidazolium, 1,3-diethylimidazolium, 1,3-dipropylimidazolium, 1,3-dibutylimidazolium, 1,3-dipentylimidazolium, 1,3-dihexylimidazolium, 1,3-diheptylimidazolium, 1,3-dioctylimidazolium, 1,3-dinonylimidazolium, 1,3-didecylimidazolium, 1-hexyl-3-methylimidazolium, 1-heptyl-3-methylimidazolium, 1-methyl-3-octylimidazolium, 1-methyl-3-nonylimidazolium, 1-decyl-3-methylimidazolium, 1-ethyl-3-hexylimidazolium, 1-ethyl-3-heptylimidazolium, 1-ethyl-3-octylimidazolium, 1-ethyl-3-nonylimidazolium or 1-decyl-3-ethylimidazolium. Particularly preferred cations are 1-ethyl-3-methylimidazolium, 1-butyl-3-methylimidazolium or 1-methyl-3-propylimidazolium.

Preferred 1-alkoxyalkyl-3-alkylimidazolium cations are, for example 1-methoxymethyl-3-methylimidazolium, 1-methoxymethyl-3-ethylimidazolium, 1-methoxymethyl-3-butylimidazolium, 1-(2-methoxyethyl)-3-methyl-imidazolium, 1-(2-methoxyethyl)-3-ethylimidazolium, 1-(2-methoxyethyl)-3-propylimidazolium, 1-(2-methoxyethyl)-3-butylimidazolium, 1-(2-ethoxyethyl)-3-methylimidazolium, 1-ethoxymethyl-3-methylimidazolium.

Preferred 1-alkenyl-3-alkylimidazolium cations are, for example 1-allyl-3-methyl-imidazolium or 1-allyl-2,3-dimethylimidazolium.

The organic cations of the compounds of formula (I) according to the invention are preferably sulfonium, ammonium, phosphonium cations of formula (2), (3) and (4) or heterocyclic cations of formula (8), particularly preferably sulfonium cations of formula (2) or heterocyclic cations of formula (8) as described above.

The organic cations of the compounds of formula (I) according to the invention are very particularly preferably heterocyclic cations of formula (8) in which HetN^{z+} is as defined above, where the substituents R^{1′} to R^{4′} each, independently of one another, have a meaning described above. The organic cation of the compound of formula (I) is very particularly preferably imidazolium, where the substituents R^{1′} to R^{4′} each, independently of one another, have a meaning described above or has one of the particularly preferred meanings of 1,3-dialkylimidazolium, 1-alkenyl-3-alkylimidazolium or 1-alkoxyalkyl-3-alkylimidazolium as described above.

Particularly suitable organic cations of the formula I are 1-butyl-1-methyl-pyrrolidinium, 1-ethyl-3-methylimidazolium, 1-ethyl-2,3-dimethylimidazolium, 1-(2-methoxyethyl)-3-methylimidazolium, 1-butyl-3-methylimidazolium, tributyl-methylammonium, tetra-n-butylammonium, tributyl-methylphosphonium, tetra-phenylphosphonium, diethyl-methylsulfonium, S-ethyl-N,N,N′,N′-tetramethylisothiouronium, 1-allyl-3-methylimidazolium, 1-allyl-2,3-dimethylimidazolium, 1-cyanomethyl-3-methylimidazolium, 1-methyl-3-propinylimidazlium, 1,1-dimethylpyrrolidinium or trimethylsulfonium.

It goes without saying to the person skilled in the art that substituents, such as, for example, C, H, N, O, Cl, F, in the compounds according to the invention may be replaced by the corresponding isotopes.

The compounds of formula (I) may be synthesized according to or based on already known methods as described in Zhang Y. and Shreeve J. M. Angew. Chem. 2011, 123, 965-967; Spielvogel B. F. et al, Inorg. Chem. 1984, 23, 3262-3265; Das M. K. et al, Bull. Chem. Soc. Jpn., 63, 1281-1283, 1990 and B. Gyori et al, Journal of Organometallic Chemistry, 255, 1983, 17-28.

Compounds of formula (I) in which Kt^{z+} is Na⁺ can be prepared additionally in a very simple way through reaction of sodium tetrahydrido-borate with trialkylsilylcyanide in which the alkyl groups independently denotes straight-chain or branched alkyl groups having 1 to 4 C atoms.

This process can be carried out in air, preferably in a dry atmosphere, for example under dry air, nitrogen or argon and may be carried out in an organic solvent or in the absence of an organic solvent if one starting material is liquid at the reaction temperature, at a temperature between 10° C. and 200° C.

Useful organic solvents are for example, acetonitrile, dimethoxyethane, diglyme, tetrahydrofurane, or methyl-tert-butyl ether.

Sodium tetrahydrido-borate is commercially available.

Trialkylsilylcyanide in which the alkyl groups independently denotes straight-chain or branched alkyl groups having 1 to 4 C atoms are in some cases commercially available or can be synthesised by known processes. For example, it is possible to generate trialkylsilylcyanide by the reaction of alkalimetalcyanide with trialkylsilylchloride in the presence of alkalimetaliodide and optionally elemental iodine (M. T. Reetz, I. Chatziiosifidis, Synthesis, 1982, p. 330; J. K. Rasmussen, S. M. Heilmann and L. R. Krepski, The Chemistry of Cyanotrimethylsilane in G. L. Larson (Ed.) “Advances in Silicon Chemistry”, Vol. 1, p. 65-187, JAI Press Inc., 1991; WO 2008/102661 A1). The use of sodium cyanide and sodium iodide or potassium cyanide or potassium iodide is particular preferred. Preferably, the alkalimetaliodide will be used in 0.1 mol/l related to 1 mol/l alkalicyanide and trialkylsilylchloride. The reaction has to be carried out in a dry atmosphere, for example under dry air, nitrogen or argon.

The alkyl groups of trialkylsilylcyanide may be the same or different. Preferably, they are the same. Examples of trialkylsilylcyanides are such as trimethylsilylcyanide, triethylsilylcyanide, dimethylethylsilylcyanide, triisopropylsilylcyanide, tripropylsilylcyanide or tributylsilylcyanide. Particularly preferred is the use of trimethylsilylcyanide.

The process for the preparation of compounds of formula (I) in which the cation is an organic cation or an inorganic cation other than sodium is a metathesis reaction (salt-exchange reaction) in which the cation will be replaced as commonly known and described in the literature such as for example, in P. Wasserscheid, T. Welton (Eds.), Ionic Liquids in Synthesis, Second Edition, WILEY-VCH, Weinheim, 2008.

In chemistry, an electrolyte is any substance containing free ions that make the substance electrically conductive. The most typical electrolyte is an ionic solution, but molten electrolytes and solid electrolytes are also possible.

An electrolyte formulation according to the invention is therefore an electrically conductive medium, basically due to the presence of at least one substance that is present in a dissolved and or in molten state and undergo dissociation into ionic species, i.e. supporting an electric conductivity via motion of ionic species. However, the said electric conductivity may not be of the major relevance to the role of the electrolyte of a dye-sensitised solar cell. Therefore, the scope of this invention is not limited to highly conductive electrolyte media.

The term electrolyte may be used for the term electrolyte formulation as well comprising all ingredients as disclosed for the electrolyte formulation.

The electrolyte formulations according to the invention may include or comprise, essentially consist of or consist of the said necessary or optional constituents. All compounds or components which can be used in the agents or compositions are either known and commercially available or can be synthesized by known processes.

Typical molar concentrations of the dihydridodicyanoborate compound in the electrolyte formulations range from 0.1 to 5.5 M, preferably from 0.8 to 3.5 M. This molar concentration in the electrolyte may be achieved with one or more compounds of formula (I) in which Kt^{z+} has a meaning as described or preferably described above.

Preferably, the molar concentration is achieved with at least one compound of formula (I) as described or preferably described above.

For the purpose of the present invention, the molar concentration refer to the concentration at 25° C.

The present invention relates furthermore to an electrolyte formulation comprising at least one compound of formula (I) as described above or preferably described together with redox active species such as iodide/tri-iodide, Ferrocene derivatives or Co(II)/Co(III) complexe couples such as Co(II)/Co(III)(dbbip)₂ in which dbbip means 2,6-bis(1′-butylbenzimidazol-2′-yl)pyridine, Co(II)/Co(III)(bpy)₃ where bpy denotes bipyridine or alkylated bipyridine derivates thereof, Co(II)/Co(III)(dmb)₃ where dmb denotes 4,4′-dimethyl-2,2′-bipyridine, Co(II)/Co(III)(dtb)₃ where dtb denotes 4,4′-di-tert-butyl-2,2′-bipyridine, Co(II)/Co(III)(phen)₃ where phen denotes 1,10-phenanthroline, preferably a redox couple of iodine and at least one iodide salt.

The electrolyte formulation of the invention preferably comprises iodine (I₂). Preferably, it comprises from 0.0005 to 7 mol/dm³, more preferably 0.01 to 5 mol/dm³ and most preferably from 0.05 to 1 mol/dm³ of I₂.

The iodide salt consists of an inorganic or organic cation and I⁻ as anion. There exists no limitation to the kind of cation. However, to limit the amount of different cations in the electrolyte formulations, especially for DSC, organic cations shall be used as already described for the compounds of formula (I). Preferably, the electrolyte formulation comprises at least one iodide salt in which the organic cation is independently selected from the group of

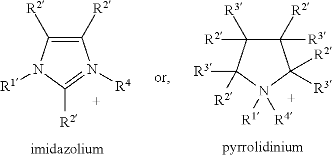

in which the substituents
R^{2′} and R^{3′} each, independently of one another, denote H or straight-chain or branched alkyl having 1 to 20 C atoms,
R^{1′} and R^{4′} each, independently of one another, denote
straight-chain or branched alkyl having 1-20 C atoms, which optionally may be partially fluorinated or perfluorinated,
straight-chain or branched alkenyl having 2-20 C atoms and one or more double bonds, which optionally may be partially fluorinated,
straight-chain or branched alkynyl having 2-20 C atoms and one or more triple bonds, which optionally may be partially fluorinated.

Preferably, the electrolyte formulation comprises one iodide salt, two iodide salts or three iodide salts. Particularly preferably, the electrolyte formulation comprises one iodide salt.

Particularly preferred examples of the at least one iodide salt are 1-ethyl-3-methylimidazolium iodide (emim I), 1-propyl-3-methylimidazolium iodide (pmim I), 1-butyl-3-methyl-imidazolium iodide (bmim I), 1-hexyl-3-methylimidazolium iodide (hmim I), 1,3-dimethyl-imidazolium iodide (mmim I), 1-allyl-3-methylimidazolium iodide (amim I), N-butyl-N-methylpyrrolidinium iodide (bmpl I) or N,N-dimethyl-pyrrolidinium iodide (mmpl I).

Other components of the electrolyte formulation are one or several further salts, solvents, and others, as indicated further below.

If the electrolyte formulation is a binary system, it comprises two salts, one further salt or iodide salt and a compound of formula (I) as described above. If the electrolyte formulation is a ternary system, it comprises two further salts and/or iodide salts and a compound of formula (I) as described above. The binary system comprises 90-10 weight %, preferably 70-30 weight %, more preferably 55-40 weight % of the further salt or iodide salt and 10-90 weight %, preferably 30-70 weight % or more preferably 45-60 weight % of the compound of formula (I) as described above. The percentages in this paragraph are expressed with respect to the total of salts (=100 weight %) present in the electrolyte formulation according to the invention. Amounts of further, generally optional components (additives) indicated below, such as N-containing compounds having unshared electron pairs, iodine, solvents, polymers, and nanoparticles, for example, are not considered therein. The same percentages apply to ternary or quaternary systems which means the total of the further salts has to be used in the given ranges, e.g. two further ionic liquids are comprised in e.g. 90-10 weight. % in the electrolyte formulation according to the invention.

According to another embodiment of the present invention, the electrolyte formulation comprises at least one further salt with organic cations comprising a quaternary nitrogen and an anion selected from a halide ion, such as F⁻, Cl⁻, a polyhalide ion, a fluoroalkanesulfonate, a fluoroalkanecarboxylate, a tris(fluoroalkylsulfonyl)methide, a bis(fluoroalkylsulfonyl)imide, bis(fluorosulfonyl)imide, a nitrate, a hexafluorophosphate, a tris-, bis- and mono-(fluoroalkyl)fluorophosphate, a tetrafluoroborate, a dicyanamide, a tricyanomethide, a tetracyanoborate, a thiocyanate, an alkylsulfonate or an alkylsulfate, with fluoroalkane-chain having 1 to 20 C atoms, preferably perfluorinated, fluoroalkyl having 1 to 20 C atoms and alkyl having 1 to 20 C atoms. Fluoroalkane-chain or fluoroalkyl is preferably perfluorinated.

Preferably, the further salts are selected from salts comprising anions such as thiocyanate, tetracyanoborate and/or bis(fluorosulfonyl)imide, particularly preferred further salts are tetracyanoborates.

The cation of the at least one further salt or of a preferred further salt may be selected amongst organic cations as defined above for the compounds of formula (I) including also the preferred meanings.

In another embodiment of the invention, guanidinium thiocyanate may be added to the electrolyte formulation according to the invention.

In a preferred embodiment, the electrolyte formulation of the present invention further comprises at least one compound containing a nitrogen atom having non-shared electron pairs. Examples of such compounds are found in EP 0 986 079 A2, starting on page 2, lines 40-55, and again from page 3, lines 14 extending to page 7, line 54, which are expressly incorporated herein by reference. Preferred examples of compounds having non-shared electron pairs include imidazole and its derivatives, particularly benzimidazole and its derivatives.

The electrolyte formulation of the present invention may comprise an organic solvent. Preferably, the electrolyte formulation comprises the compound comprising a dihydridodicyanoborate anion in the range between 5% to 70% and the organic solvent in the range between 70% to 0% based on the total weight of the formulation. Particularly preferably, the electrolyte formulation comprises less than 50% of an organic solvent or less than 40%, more preferably less than 30%, still more preferably less than 20% and even less than 10%. Most preferably, the electrolyte formulation comprises less than 5% of an organic solvent. For example, it is substantially free of an organic solvent. Percentages are indicated on the basis of weight %.

Organic solvents, if present in such amounts as indicated above, may be selected from those disclosed in the literature. Preferably, the solvent, if present, has a boiling point higher than 160 degrees centigrade, more preferably higher than 190 degrees such as propylene carbonate, ethylene carbonate, butylene carbonate, gamma-butyrolactone, gamma-valerolactone, glutaronitrile, adiponitrile, N-methyloxazolidinone, N-methylpyrrolidinone, N,N′-dimethylimidazolidinone, N,N-dimethylacetamide, cyclic ureas preferably 1,3-dimethyl-2-imidazolidinone or 1,3-dimethyl-3,4,5,6-tetrahydro-2(1H)-pyrimidinone, glymes preferably tetraglyme, sulfolane, sulfones which are preferably asymmetrically substituted such as 2-ethanesulfonyl-propane, 1-ethanesulfonyl-2-methyl-propane or 2-(propane-2-sulfonyl)-butane, 3-methylsulfolane, dimethylsulfoxide, trimethylphosphate and methoxy-substituted nitriles. Other useful solvents are acetonitrile, benzonitrile and or valeronitrile. Preferred organic solvents are gamma-butyrolactone and tetraglyme.

If a solvent is present in the electrolyte formulation, there may further be comprised a polymer as gelling agent, wherein the polymer is polyvinylidenefluoride, polyvinylidene-hexafluropropylene, polyvinylidene-hexafluoropropylene-chlorotrifluoroethylene copolymers, nafion, polyethylene oxide, polymethylmethacrylate, polyacrylonitrile, polypropylene, polystyrene, polybutadiene, polyethyleneglycol, polyvinylpyrrolidone, polyaniline, polypyrrole, polythiophene. The purpose of adding these polymers to electrolyte formulations is to make liquid electrolytes into quasi-solid or solid electrolytes, thus improving solvent retention, especially during aging.

The electrolyte formulation of the invention may further comprise metal oxide nanoparticles like SiO₂, TiO₂, Al₂O₃, MgO or ZnO, for example, which are also capable of increasing solidity and thus solvent retention.

The electrolyte formulation of the invention has many applications. For example, it may be used in an optoelectronic and/or electrochemical device such as a photovoltaic cell, a light emitting device, an electrochromic or photo-electrochromic device, an electrochemical sensor and/or biosensor.

The present invention therefore relates further to the use of the electrolyte formulation as described in detail above in an electrochemical and/or optoelectronic device which is a photovoltaic cell, a light emitting device, an electrochromic or photo-electrochromic device, an electrochemical sensor and/or biosensor. Preferably, the electrolyte formulation may be used in dye sensitized solar cells.

The present invention therefore relates furthermore to an electrochemical and/or optoelectronic device which is a photovoltaic cell, a light emitting device, an electrochromic or photo-electrochromic device, an electrochemical sensor and/or biosensor comprising an electrolyte formulation comprising at least one compound comprising a dihydridodicyanoborate anion.

Preferably, the at least one compound comprising a dihydridodicyanoborate anion is a compound of formula (I) as described above including all preferred meanings.

According to a preferred embodiment, the device of the present invention is a dye or quantum dot sensitized solar cell, particularly preferably a dye sensitized solar cell.

In dye-sensitized solar cells, a dye is used to absorb the sunlight to convert into the electrical energy. There are no restrictions per se with respect to the choice of the dye as long as the LUMO energy state is marginally above the conduction bandedge of the photoelectrode to be sensitized. Examples of dyes are disclosed in EP 0 986 079 A2, EP 1 180 774 A2 or EP 1 507 307 A1.

Preferred dyes are organic dyes such as MK-1, MK-2 or MK-3 (its structures are described in FIG. 1 of N. Koumura et al, J. Am. Chem. Soc. Vol 128, no. 44, 2006, 14256-14257), D102 (CAS no. 652145-28-3), D-149 (CAS no. 786643-20-7), D205 (CAS no. 936336-21-9), D358 (CAS no. 1207638-53-6), YD-2 as described in T. Bessho et al, Angew. Chem. Int. Ed. Vol 49, 37, 6646-6649, 2010, Y123 (CAS no. 1312465-92-1), bipyridin-Ruthenium dyes such as N3 (CAS no. 141460-19-7), N719 (CAS no. 207347-46-4), Z907 (CAS no. 502693-09-6), C101 (CAS no. 1048964-93-7), C106 (CAS no. 1152310-69-4), K19 (CAS no. 847665-45-6), HRS-1 (CAS no. 906061-30-1 as disclosed in K. J. Jiang et al, Chem. Comm. 2460, 2006) or terpyridine-Ruthenium dyes such as N749 (CAS no. 359415-47-7). The structure of D205 is

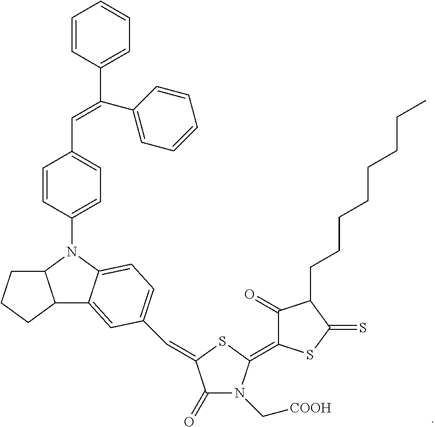 [SMILES: CCCCCCCCC1C(=O)/C(=c2\s/c(=C\c3ccc4c(c3)C3CCCC3N4c3ccc(C=C(c4ccccc4)c4ccccc4)cc3)c(=O)n2CC(=O)O)SC1=S]

The structure of D358 is

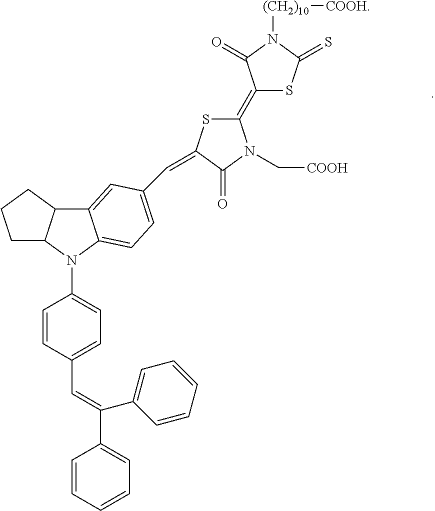

Particularly preferred dyes are Z907 or Z907Na which are both an amphiphilic ruthenium sensitizer, C106, D358 or HRS-1. The dye Z907Na means NaRu(2,2′-bipyridine-4-carboxylic acid-4′-carboxylate)(4,4′-dinonyl-2,2′-bipyridine)(NCS)₂.

Very particularly preferred dyes are Z907 or Z907Na and/or D358. Very particularly preferred dyes are Z907 or Z907Na.

In a special embodiment, the dye is coadsorbed with a phosphinic acid. A preferred example of a phosphinic acid is bis(3,3-dimethyl-butyl)-phosphinic acid (DINHOP) as disclosed in M. Wang et al, Dalton Trans., 2009, 10015-10020.

For example, a dye-sensitized solar cell comprises a photo-electrode, a counter electrode and, between the photo-electrode and the counter electrode, an electrolyte formulation or a charge transporting material, and wherein a sensitizing dye is absorbed on the surface of the photo-electrode, on the side facing the counter electrode.

According to a preferred embodiment of the device according to the invention, it comprises a semiconductor, the electrolyte formulation as described above and a counter electrode.

According to a preferred embodiment of the invention, the semiconductor is based on material selected from the group of Si, TiO₂, SnO₂, Fe₂O₃, WO₃, ZnO, Nb₂O₅, CdS, ZnS, PbS, Bi₂S₃, CdSe, GaP, InP, GaAs, CdTe, CuInS₂, and/or CuInSe₂. Preferably, the semiconductor comprises a mesoporous surface, thus increasing the surface optionally covered by a dye and being in contact with the electrolyte. Preferably, the semiconductor is present on a glass support or plastic or metal foil. Preferably, the support is conductive.

The device of the present invention preferably comprises a counter electrode. For example, fluorine doped tin oxide or tin doped indium oxide on glass (FTO- or ITO-glass, respectively) coated with Pt, carbon of preferably conductive allotropes, polyaniline or poly (3,4-ehtylenedioxythiophene) (PEDOT). Metal substrates such as stainless steel or titanium sheet may be possible substrates beside glass.

The device of the present invention may be manufactured as the corresponding device of the prior art by simply replacing the electrolyte by the electrolyte formulation of the present invention. For example, in the case of dye-sensitized solar cells, device assembly is disclosed in numerous patent literature, for example WO 91/16719 (examples 34 and 35), but also scientific literature, for example in Barbé, C. J., Arendse, F., Comte, P., Jirousek, M., Lenzmann, F., Shklover, V., Grätzel, M. J. Am. Ceram. Soc. 1997, 80, 3157; and Wang, P., Zakeeruddin, S. M., Comte, P., Charvet, R., Humphry-Baker, R., Grätzel, M. J. Phys. Chem. B 2003, 107, 14336.

Preferably, the sensitized semi-conducting material serves as a photoanode. Preferably, the counter electrode is a cathode.

The present invention provides a method for preparing a photoelectric cell comprising the step of bringing the electrolyte formulation of the invention in contact with a surface of a semiconductor, said surface optionally being coated with a sensitizer. Preferably, the semiconductor is selected from the materials given above, and the sensitizer is preferably selected from quantum dots and/or a dye as disclosed above, particularly preferably selected from a dye.

Preferably, the electrolyte formulation may simply be poured on the semiconductor. Preferably, it is applied to the otherwise completed device already comprising a counter electrode by creating a vacuum in the internal lumen of the cell through a hole in the counter electrode and adding the electrolyte formulation as disclosed in the reference of Wang et al., J. Phys. Chem. B 2003, 107, 14336.

The present invention will now be illustrated, without limiting its scope, by way of the following examples:

### EXAMPLE 1

### Synthesis, Characterisation and Viscosity/Conductivity Measurements of 1-ethyl-3-methylimidzolium tetracyanoborate (emim TCB) and 1-ethyl-3-methylimidzolium dihydridodicyanoborate

A) 1-Ethyl-3-methylimidazolium tetracyanoborate is synthesized according to WO 2004/072089, examples 9 and 12 and E. Bernhardt et al., Z. Anorg. Allg. Chem., 2003, 629, 677-685.

B) 1-Ethyl-3-methylimidazolium dihydridodicyanoborate:

### Step 1:

NaBH₄+2Me₃SiCN→Na[BH₂(CN)₂]+2Me₃SiH

Na[BH₄] (37.83 g, 1 mol) and (CH₃)₃SiCN (302 g, 3.04 mol) is mixed and stirred under reflux for two days keeping the reaction mixture in an inert atmosphere (pil bath 150° C.). The resultant trimethylsilane ((CH₃)₃SiH, b.p. 6.7° C.) is trapped via cooling with an ice-bath. Excessive trimethylsilylcyanide is subsequently thoroughly removed in vacuo and the resulting salt of sodium dihydridodicyanoborate is dried in vacuo. Yield 88.95 g (1 mol, 100%). The product is characterized by means of NMR and X-ray analysis:

x-ray structure: Na[BH₂(CN)₂]: a=7.8136(3), b=7.8656(4), c=16.1764(7) Å, α=78.489(4), β=76.882(3), γ=72.197(4) °, V=912.75, Z=8, P-1, T=150 K. ¹H{¹¹B}-NMR (Lösungsmittel: CD₃CN; Referenz: TMS): δ, ppm=0.99 s (2H, BH₂).

¹¹B-NMR (Lösungsmittel: CD₃CN; Referenz: Et₂O.BF₃): 5, ppm=−42.2 t, ¹J_{B,H}=95 Hz.

### Step 2:

2Na[BH₂(CN)₂]+K₂CO₃→2K[BH₂(CN)₂]+Na₂CO₃

Na[BH₂(CN)₂] (24.8 g, 0.28 mol) is dissolved in deionized water (20 ml), and K₂CO₃ is added. The solution is diluted with 260 ml tetrahydrofuran and stirred vigorously. The organic phase is separated and dried using K₂CO₃. After filtration the solvent is removed using a rotary evaporator and the resulting salt K[BH₂(CN)₂] is dried in vacuo. Yield 28.1 g (0.27 mol, 96%).

x-ray structure: K[BH₂(CN)₂]: a=7.3073(3), b=9.5312(3), c=7.3659(3) Å, α=90, β=109.965(5), γ=90°, V=482.18 Z=4, P2₁/c, T=150 K.

### Step 3:

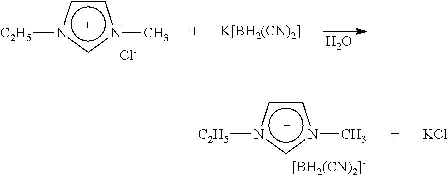

K[BH₂(CN)₂] (14.04 g) is dissolved in deionized water (10 ml), and 1-ethyl-3-methylimidazolium chloride [EMIM]Cl (19.8 g), dissolved in deionized water (10 ml), is added by mixing. The ionic liquid is extracted with CH₂Cl₂ (130 ml+2×50 ml). The combined organic phases are washed with deionized water (4×20 ml) and dried using Na₂SO₄. After filtration the CH₂Cl₂ is removed using a rotary evaporator. The resulting ionic liquid 1-ethyl-3-methylimidazolium dihydridodicyanoborate is dried while stirring under vacuo at 50° C. for two days. Yield 16.3 g (0.093 mol), 69%. Water content (Karl-Fischer Titration) is 44 ppm; chloride content is 18 ppm.

Viscosity 10.2 mPa s (20° C.).

Decomposition temperature (onset): app. 290° C. (DSC/TGA).

The product is characterised with NMR-spectroscopy:

¹¹B NMR (Solvent: CD₃CN; Reference substance: Et₂O.BF₃), δ, ppm: −42.0 t, ¹J_{H,B}=95 Hz.

¹H{¹¹B} NMR(Solvent: CD₃CN; Reference substance: TMS), δ, ppm: 8.56 br.s (—1H, CH); 7.45 d,d (1H, CH), ³J_{H,H}=1.8 Hz; 7.39 d,d (1H, CH), ³J_{H,H}=1.7 Hz; 4.21 q (2H, CH₂), ³J_{H,H}=7.3 Hz; 3.86 s (3H, CH₃); 1.48 t (3H, CH₃), ³J_{H,H}=7.3; 0.93 br. s (2H, BH₂).

C) N-Butyl-N-methylpyrrolidinium dihydridodicyanoborate

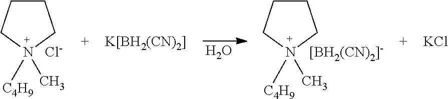

K[BH₂(CN)₂] (13.9 g, 27.2 mmol) is dissolved in deionized water (10 ml), and 1-butyl-1-methylpyrrolidinium chloride [bmpl]Cl (23.8 g), dissolved in deionized water (10 ml), is added by mixing. The ionic liquid is extracted with CH₂Cl₂ (2×100 ml+50 ml). The combined organic phases are washed with deionized water (4×20 ml) and dried using Na₂SO₄. After filtration the CH₂Cl₂ is removed using a rotary evaporator. The resulting ionic liquid N-butyl-N-methylpyrrolidinium dihydridodicyanoborate is dried while stirring under vacuo at 50° C. for two days. Yield 23.0 g (0.111 mol), 83%.

Chloride content is 21 ppm.

Viscosity is 23.6 mPa s (20° C.).

Decomposition temperature (onset): 237° C. (DSC/TGA).

The product is characterised with NMR-spectroscopy:

¹¹B NMR (Solvent: CD₃CN; Reference substance: Et₂O.BF₃), δ, ppm: −42.0 t, ¹J_{H,B}=94 Hz.

¹H{¹¹B} NMR(Solvent: CD₃CN; Reference substance: TMS), δ, ppm: 3.45 m (4H, 2CH₂,); 3.27 m (2H, CH₂); 2.99 s (3H, CH₃); 2.19 m (4H, 2CH₂); 1.75 m (2H, CH₂); 1.40 m (2H, CH₂); 0.98 t (3H, CH₃), ³J_{H,H}=7.3 Hz; 1.01 s (2H, BH₂).

Table 1 gives specific parameters of the ionic liquids used:

| | | | Dynamic | Specific |
|---|---|---|---|---|
| | | Density | viscosity | conductivity |
| Compound | T [° C.] | [g/cm³] | [mPa/s] | [mS/cm] |
| emim TCB* | 20 | 1.04 | 22.2 | 13.0 |
| | 40 | 1.03 | 11.2 | 23.2 |
| | 60 | 1.01 | 6.75 | 35.9 |
| | 80 | 1.00 | 4.53 | 50.5 |
| emim | 20 | 0.98 | 10.2 | 31.9 |
| dihydridodicyanoborate | 40 | 0.97 | 6.47 | 50.5 |
| | 60 | 0.96 | 4.47 | 69.5 |
| | 80 | 0.95 | 3.30 | |
| bmpl | 20 | 0.93 | 23.6 | 13.3 |
| dihydridodicyanoborate | 40 | 0.92 | 13.7 | 21.8 |
| | 60 | 0.91 | 8.82 | 31.8 |
| | 80 | 0.90 | 6.12 | 44.7 |
| bmpl TCB* | 20 | 0.98 | 62.7 | 4.2 |

*not according to the invention

### EXAMPLE 2

### Preparation of Triethyl-Sulfonium Dihydrido-Dicyano-Borate, [(C₂H₅)₃S]+[BH₂(CN)₂]⁻

Na[BH₂(CN)₂]+[(C₂H₅)₃S]I+AgCl→[(C₂H₅)₃S][BH₂(CN)₂]+NaCl+AgI

The solution of 36.91 g (217 mmol) AgNO₃ in 100 mL of water is treated with 20 mL 37% HCl. Precipitant (AgCl) is filtered off and washed 5 time with 150 mL of water. AgCl obtained in this way is vigorously stirred for 24 hours with 13.82 g (56.1 mmol) of triethyl sulfonium iodide, [Et₃S]l, in 60 mL of water. The yellow precipitant is filtered off and the aqueous solution of triethyl sulfonium chloride, [Et₃S]Cl, is reacted with 4.87 g (55.4 mmol) of sodium dihydrido-dicyano-borate, Na[BH₂(CN)₂]. The reaction mixture is extracted with 100+50+50 mL CH₂Cl₂. The organic phase is washed with 10+10+10 mL of water and dried with Na₂SO₄. The solution is filtered and the solvent is distilled off. The residue is dried in vacuum at 40° C. over night. 8.06 g (43.8 mmol) of liquid triethylsulfonium dihydrido-dicyano-borate, [Et₃S][BH₂(CN)₂], is obtained. Yield is 79% calculating on the dihydrido-dicyano-borate, Na[BH₂(CN)₂], used. The product is characterized by means of NMR spectroscopy.

### [BH₂(CN)₂]⁻

¹¹B-NMR (Solvent: CD₃CN), δ, ppm: −41.9 t, ¹J(¹H, ¹¹B)=94 Hz

### [(C₂H₅)₃S]⁺

¹H-NMR (Solvent: CD₃CN), δ, ppm: 1.42 t (CH₃), ³J_{H,H}=7.4 Hz; 3.23 q (CH₂), ³J_{H,H}=7.4 Hz.

¹³C-NMR (Solvent: CD₃CN), δ, ppm: 9.0 q,m (CH₃), ¹J_{C,H}=131 Hz, ²J_{C,H}=4 Hz; 33.2 t,m (CH₂), ¹J_{C,H}=146 Hz, ^{2,3}J_{C,H}=2-4 Hz, ¹J_{C,C}=34 Hz.

### EXAMPLE 3

### Formulations and Device

The following electrolyte formulations are synthesized to demonstrate the unexpected advantage of electrolyte formulations according to the invention relative to electrolyte formulations of the prior art containing emim TCB.

The electrolyte formulations are prepared through mixing of one or more of 1,3-dimethylimidazolium iodide (mmiml), 1-ethyl-3-methylimidazolium iodide (emiml), iodine, N-butylbenzimidazole (NBB) and guanidinium thiocyanate (guaSCN) and the corresponding ionic liquid as indicated such as emim TCB or emim [BH₂(CN)₂] or bmpl [BH₂(CN)₂] (N-butyl-N-methylpyrrolidinium dihydridodicyanoborate=bmpl DHB) in weight % as listed below.

| | weight % |
|---|---|
| Electrolyte 1 | |
| I₂ | 2 |
| mmim I | 21 |
| emim I | 21 |
| guaSCN | 0.7 |
| NBB | 5 |
| emim TCB | 50.3 |
| total | 100 |
| Electrolyte 2 | |
| I2 | 2 |
| mmim I | 21 |
| emim I | 21 |
| guaSCN | 0.7 |
| NBB | 5 |
| bmpl TCB | 50.3 |
| Total | 100 |
| Electrolyte 3 | |
| I₂ | 2 |
| mmim I | 21 |
| emim I | 21 |
| guaSCN | 0.7 |
| NBB | 5 |
| emim BH₂(CN)₂ | 50.3 |
| total | 100 |
| Electrolyte 4 | |
| I₂ | 2 |
| mmim I | 21 |
| emim I | 21 |
| guaSCN | 0.7 |
| NBB | 5 |
| bmpl BH₂(CN)₂ | 50.3 |
| total | 100 |

The above cited compounds are commercially available or are synthesized according to known literature methods.

The dye sensitized solar cells are fabricated as disclosed in U.S. Pat. No. 5,728,487 or WO 2007/093961:

A double-layer, mesoporous TiO₂ electrode was prepared as disclosed in Wang P et al., J. Phys. Chem. B 2003, 107, 14336, in particular page 14337, in order to obtain a photoanode consisting of a double layer structure. To prepare a transparent nanoporous TiO₂ electrode, a screen printing paste containing terpineol solvent and nanoparticulate TiO₂ of anatase phase with 20 nm diameter was deposited on a transparent conductive substrate to 5 mm×5 mm squared shape by using a hand printer. The paste was dried for 10 minutes at 120 degrees Celsius. Another screen printing paste containing TiO₂ with 400 nm diameter was then deposited on top of the nanoporous layer to prepare an opaque layer. The double layer film was then sintered at 500 degrees Celsius for an hour with the result of an underlying transparent layer (7 microns thick) and a top opaque layer (4 microns thick). After sintering, the electrode was immersed in 40 mM aqueous solution of TiCl₄ (Merck) for 30 minutes at 70 degrees Celsius and then rinsed with pure water sufficiently. Thus TiCl₄-treated electrode was dried at 500 degrees Celsius for 30 minutes just before dye sensitization. The electrode was dipped into a 0.3 mM Z907 dye solution of acetonitrile (Merck HPLC grade) and tert-butyl alcohol (Merck), v:v=1:1 for 60 hours at 19 degrees Celsius. The counter electrode was prepared with thermal pyrolysis method as disclosed in the reference above. A droplet of 5 mM solution of platinic acid (Merck) was casted at 8 μl/cm2 and dried on a conductive substrate. The dye sensitized solar cell was assembled by using 30 micron thick Bynel (DuPont, USA) hot-melt film to seal up by heating. The internal space was filled with each of the electrolyte formulations as described above to produce the corresponding devices.

The dye Z907 is an amphiphilic ruthenium sensitizer Ru(2,2′-bipyridine 4,4′-dicarboxylic acid) (4,4′-dinonyl-2,2′-bipyridine)(NCS)₂ or synonymously [Ru(H2dcbpy)(dnbpy)(NCS)₂].

In order to obtain accurate light intensity level, Air Mass 1.5 Global (AM 1.5G) simulated sunlight is calibrated spectrally according to Seigo Ito et al, “Calibration of solar simulator for evaluation of dye-sensitized solar cells”, Solar Energy Materials & Solar Cells, 82, 2004, 421.

The measurements of photocurrent-voltage curves are carried out under Air Mass 1.5 simulated sunlight (AM 1.5) with temperature control for devices fabricated as described above containing electrolytes 1 to 4 placed on a black plate chilled down to 25° C. under 1 Sun illumination. A photomask of 4 mm×4 mm is placed on top of the devices to define the light projection area. The cell gap is around 20 micron.

Energy conversion efficiency is generally the ratio between the useful output of an energy conversion machine and the input of light radiation, in energy terms, determined by using adjustable resistant load to optimize the electric power output.

Table 2 summarizes the results of the measurements of the above cited electrolyte formulations:

| Electrolyte | J_{SC} [mAcm⁻²] | V_{OC} [V] | FF | η [%] |
|---|---|---|---|---|
| 1* | 10.52 | 0.71 | 0.71 | 5.34 |
| 2* | 9.74 | 0.75 | 0.60 | 4.28 |
| 3 | 10.73 | 0.72 | 0.71 | 5.50 |
| 4 | 10.86 | 0.74 | 0.62 | 4.96 |

*not according to the invention
J_{SC} = short circuit current
V_{OC} = open circuit voltage
FF = fill factor
η = power conversion efficiency

Table 2 documents that electrolytes comprising dihydridodicyanoborate as anion perform better or equal than electrolytes comprising TCB as anion if the same cation is used.

### EXAMPLE 4

### Formulations and Device

The following electrolyte formulations are synthesized to demonstrate the unexpected advantage of electrolyte formulations containing optionally organic solvents according to the invention relative to electrolyte formulations containing emim TCB and optionally organic solvents.

The electrolyte formulations are prepared through mixing of one or more of 1,3-dimethylimidazolium iodide (mmiml), 1-ethyl-3-methylimidazolium iodide (emiml), 1-propyl-3-methylimidazolium iodide (pmiml), 1-allyl-3-methylimidazolium iodide (allylMIMI), iodine, N-butylbenzimidazole (NBB), guanidinium thiocyanate (guaSCN), γ-butyrolacton (GBL), tetraethylenglycoldimethylether (TG) and the corresponding ionic liquid as indicated such as emim TCB or emim [BH₂(CN)₂] (=emim DHB) in weight % as listed below.

| | weight % |
|---|---|
| Electrolyte 5 | |
| I₂ | 3.5 |
| pmim I | 21 |
| mmim I | 20 |
| guaSCN | 0.5 |
| NBB | 5 |
| emim TCB | 25 |
| GBL | 25 |
| total | 100 |
| Electrolyte 6 | |
| I₂ | 3.5 |
| pmim I | 21 |
| mmim I | 20 |
| guaSCN | 0.5 |
| NBB | 5 |
| emim DHB | 25 |
| GBL | 25 |
| total | 100 |
| Electrolyte 7 | |
| I₂ | 3.5 |
| pmim I | 21 |
| mmim I | 20 |
| guaSCN | 0.5 |
| NBB | 5 |
| emim TCB | 25 |
| TG | 25 |
| total | 100 |
| Electrolyte 8 | |
| I₂ | 3.5 |
| pmim I | 21 |
| mmim I | 20 |
| guaSCN | 0.5 |
| NBB | 5 |
| emim DHB | 25 |
| TG | 25 |
| total | 100 |
| Electrolyte 9 | |
| I₂ | 4.3 |
| emim I | 15 |
| mmim I | 14.2 |
| allylMIMI | 15.1 |
| guaSCN | 0.8 |
| NBB | 5.9 |
| emim TCB | 44.7 |
| total | 100 |
| Electrolyte 10 | |
| I₂ | 4.3 |
| emim I | 15 |
| mmim I | 14.2 |
| allylMIMI | 15.1 |
| guaSCN | 0.8 |
| NBB | 5.9 |
| emim DHB | 44.7 |
| total | 100 |

The above cited compounds are commercially available or are synthesized according to known literature methods or as described herein.

The dye sensitized solar cells for the following measurements (masterplates) are commercially available from ISE (Institut für solare Energiesysteme, Freiburg), serial no. 010311 which are fabricated based on the disclosure of U.S. Pat. No. 5,728,487 or WO 2007/093961:

The used titaniumdioxide paste is commercially available from Dyesol, Australia, serial no. DSL 18 NRT and DSL 18NRT AO.

The titanium dioxide is screen printed three times: two times with the titaniumdioxide paste DSL 18 NRT (each layer thickness=2 μm) and one time with the titaniumdioxide paste DSL 18NRT AO (layer thickness 5 to 6 μm).

The masterplate is irrigated with a solution of 30 mg Z907 dye in 62.5 ml ethanol for 4 hours.

The electrolyte formulations as described above are filled into the internal space of the prepared masterplate to produce the corresponding devices.

The dye Z907 is an amphiphilic ruthenium sensitizer Ru(2,2′-bipyridine 4,4′-dicarboxylic acid) (4,4′-dinonyl-2,2′-bipyridine)(NCS)₂ or synonymously [Ru(H2dcbpy)(dnbpy)(NCS)₂].

The measurements of photocurrent-voltage curves are carried out under Solarsimulator Sun 2000 from Abet Technologies, Model 11018, with temperature control for devices fabricated as described above containing electrolytes 7 to 14 placed on a black plate chilled down to 25° C. under 1 Sun illumination. The measured area of the solar cell is 5 mm to 25 mm.

Energy conversion efficiency is generally the ratio between the useful output of an energy conversion machine and the input of light radiation, in energy terms, determined by using adjustable resistant load to optimize the electric power output.

Table 3 summarizes the results of the measurements of the above cited electrolyte formulations as average values:

| Electrolyte | J_{SC} [mAcm⁻²] | V_{OC} [V] | FF [%] | η [%] |
|---|---|---|---|---|
| 5* | 9.8 | 0.63 | 48.5 | 3.0 |
| 6 | 10.8 | 0.61 | 54.4 | 3.6 |
| 7* | 9.2 | 0.61 | 59.6 | 3.4 |
| 8 | 10.5 | 0.61 | 44.2 | 2.8 |
| 9* | 6.6 | 0.60 | 66.9 | 2.6 |
| 10 | 6.6 | 0.59 | 49.0 | 1.9 |

*not according to the invention
J_{SC} = short circuit current
V_{OC} = open circuit voltage
FF = fill factor
η = power conversion efficiency

Table 3 documents that electrolytes comprising dihydridodicyanoborate as anion perform better or comparable to electrolytes comprising TCB as anion if the same cation is used.

### EXAMPLE 5

### Formulations and Device

The following electrolyte formulations are synthesized to demonstrate the unexpected advantage of electrolyte formulations according to the invention (emim DHB) relative to corresponding electrolyte formulations containing emim TCB.

The electrolyte formulations are prepared through mixing of 1,3-dimethylimidazolium iodide (mmiml), iodine, N-butylbenzimidazole (NBB), guanidinium thiocyanate (guaSCN) and the corresponding ionic liquid as indicated such as emim TCB, emim [BH₂(CN)₂] (emim DHB) or mixtures of emim TCB and emim DHB in weight % as listed below.

TABLE 4
electrolytes 11 to 15

| Ingredients | Electrolyte | | | | |
|---|---|---|---|---|---|
| in weight % | 11* | 12 | 13 | 14 | 15 |
| I₂ | 1.3 | 1.3 | 1.3 | 1.3 | 1.3 |
| mmimI | 35.0 | 35.0 | 35.0 | 35.0 | 35.0 |
| guaSCN | 0.7 | 0.7 | 0.7 | 0.7 | 0.7 |
| emim TCB | 60.0 | 45.0 | 30.0 | 15.0 | 0.0 |
| emim DHB | 0.0 | 15.0 | 30.0 | 45.0 | 60.0 |
| NBB | 3.0 | 3.0 | 3.0 | 3.0 | 3.0 |

*not according to the invention

The dye sensitized solar cells are fabricated and measured as disclosed in example 3.

Table 5 summarizes the results of the measurements of the above cited electrolyte formulations:

| Electrolyte | J_{SC} [mAcm⁻²] | V_{OC} [V] | FF | η [%] |
|---|---|---|---|---|
| 11* | 10.06 | 0.69 | 0.69 | 4.64 |
| 12* | 11.17 | 0.71 | 0.70 | 5.56 |
| 13 | 11.27 | 0.71 | 0.69 | 5.50 |
| 14 | 11.06 | 0.70 | 0.69 | 5.16 |
| 15 | 11.84 | 0.69 | 0.69 | 5.66 |

*not according to the invention
J_{SC} = short circuit current
V_{OC} = open circuit voltage
FF = fill factor
η = power conversion efficiency

Table 5 documents that electrolytes comprising dihydridodicyanoborate as anion or electrolytes comprising mixtures of dihydridodicyanoborate and tetracyanoborate anions perform better than electrolytes comprising TCB as anion if the same cation is used.

### EXAMPLE 6

### Formulations and Device

The following electrolyte formulations are synthesized to demonstrate the advantage of electrolyte formulations according to the invention (emim DHB) together with emim FSI in which FSI means bis(fluorosulfonyl)imide relative to corresponding electrolyte formulations containing emim TCB and emim FSI or emim TCB.

The electrolyte is mixed according to example 3.

TABLE 6
electrolytes 11 to 15

| Ingredients | Electrolyte | | |
|---|---|---|---|
| in weight % | 16* | 17* | 18 |
| I₂ | 1.3 | 1.3 | 1.3 |
| mmimI | 35.0 | 35.0 | 35.0 |
| guaSCN | 0.7 | 0.7 | 0.7 |
| emim TCB | 60.0 | 30.0 | 0.0 |
| emim DHB | 0.0 | 0.0 | 30.0 |
| emim FSI | 0.0 | 30.0 | 30.0 |
| NBB | 3.0 | 3.0 | 3.0 |

*not according to the invention

The dye sensitized solar cells are fabricated and measured as disclosed in example 3 and the dyes Z907 and D358 are used.

Table 7 summarizes the results of the measurements of the above cited electrolyte formulations:

| Electrolyte | J_{SC} [mAcm⁻²] | V_{OC} [V] | FF | η [%] |
|---|---|---|---|---|
| D358 | | | | |
| 16* | 10.06 | 0.71 | 0.70 | 4.99 |
| 17* | 11.12 | 0.67 | 0.68 | 5.08 |
| 18 | 11.61 | 0.67 | 0.68 | 5.26 |
| Z907 | | | | |
| 17* | 11.16 | 0.72 | 0.69 | 5.49 |
| 18 | 12.56 | 0.69 | 0.64 | 5.51 |

*not according to the invention

### EXAMPLE 7

### Formulations and Device

The following electrolyte formulations are synthesized to demonstrate the unexpected advantage of electrolyte formulations according to the invention:

The electrolyte formulations are prepared through mixing of 1-ethyl-3-methylimidazolium iodide (emiml) or 1,1-dimethylpyrrolidinium iodide (mmpll), iodine, N-butylbenzimidazole (NBB), guanidinium thiocyanate (guaSCN) and the corresponding ionic liquid as indicated such as emim TCB or emim [BH₂(CN)₂] (emim DHB) and bmpl TCB or bmpl DHB (bmpl=1-butyl-1-methylpyrrolidinium).

TABLE 8
electrolytes 11 to 15

| Ingredients | Electrolyte | | | |
|---|---|---|---|---|
| in weight % | 19* | 20 | 21* | 22 |
| I₂ | 1.3 | 1.3 | 1.3 | 1.3 |
| emimI | 35.0 | 35.0 | 0.0 | 0.0 |
| mmplI | 0.00 | 0.00 | 35.00 | 35.00 |
| guaSCN | 0.7 | 0.7 | 0.7 | 0.7 |
| emim TCB | 60.0 | 0.0 | 0.00 | 0.0 |
| emim DHB | 0.0 | 60.0 | 0.0 | 0.00 |
| bmpl TCB | 0.00 | 0.00 | 60.0 | 0.00 |
| bmpl DHB | 0.00 | 0.00 | 0.00 | 60.0 |
| NBB | 3.0 | 3.0 | 3.0 | 3.0 |

*not according to the invention

The dye sensitized solar cells are fabricated and measured as disclosed in example 3.

Table 9 summarizes the results of the measurements of the above cited electrolyte formulations:

| Electrolyte | Jsc [mAcm⁻²] | V_{OC} [V] | FF | η [%] |
|---|---|---|---|---|
| 19* | 9.27 | 0.72 | 0.60 | 4.02 |
| 20 | 11.70 | 0.71 | 0.56 | 4.66 |
| 21* | 5.42 | 0.71 | 0.62 | 2.38 |
| 22 | 7.65 | 0.66 | 0.53 | 2.67 |

*not according to the invention

1. An electrolyte formulation comprising at least one compound comprising a dihydridodicyanoborate anion.

2. An electrolyte formulation according to claim 1 in which the compound comprising a dihydridodicyanoborate anion corresponds to formula (I)
Kt^{z+}z[BH₂(CN)₂]⁻ (I)
in which
z denotes 1, 2, 3 or 4 and
Kt^{z+} denotes an inorganic cation or an organic cation selected from the group of an oxonium cation of formula (1) or a sulfonium cation of formula (2))
[(R^{o})₃O]⁺ (1)
[(R^{o})₃S]⁺ (2),
where R^{o} each independently of one another denotes a straight-chain or branched alkyl group having 1-8 C atoms, non-substituted phenyl or phenyl which is substituted by R^{1*}, OR′, N(R′)₂, CN or halogen and in case of sulfonium cations of formula (2) additionally denotes each independently (R′″)₂N— and R′ is independently of each other H, non-fluorinated, partially fluorinated or perfluorinated straight-chain or branched C₁- to C₁₈-alkyl, saturated C₃- to C₇-cycloalkyl, non-substituted or substituted phenyl, R^{1*} is independently of each other non-fluorinated, partially fluorinated or perfluorinated straight-chain or branched C₁- to C₁₈-alkyl, saturated C₃- to C₇-cycloalkyl, non-substituted or substituted phenyl and R′″ is independently of each other straight-chain or branched C₁ to C₆ alkyl;
an ammonium cation, which conforms to the formula (3)
[NR₄]⁺ (3),
where
R in each case, independently of one another, denotes
H, OR′, N(R′)₂, with the proviso that a maximum of one R in formula (3) is OR′ or N(R′)₂,
straight-chain or branched alkyl having 1-20 C atoms,
straight-chain or branched alkenyl having 2-20 C atoms and one or more double bonds,
straight-chain or branched alkynyl having 2-20 C atoms and one or more triple bonds,
saturated, partially or fully unsaturated cycloalkyl having 3-7 C atoms, which may be substituted by straight-chain or branched alkyl groups having 1-6 C atoms, where one or two R may be fully substituted by halogens, in particular —F and/or —Cl, and one or more of the substituents R may be partially substituted by halogens, in particular —F and/or —Cl, and/or by —OH, —OR′, —CN, —N(R′)₂, —C(O)OH, —C(O)OR′, —C(O)R′, —C(O)N(R′)₂, —SO₂N(R′)₂, —C(O)X, —SO₂OH, —SO₂X, —NO₂, —SR′, —S(O)R′, —SO₂R′ and where one or two non-adjacent carbon atoms in R which are not in the α-position may be replaced by atoms and/or atom groups selected from the group —O—, —S—, —S(O)—, —SO₂—, —SO₂O—, —C(O)—, —C(O)O—, —N⁺(R′)₂—, —P(O)R′O—, —C(O)NR′—, —SO₂NR′—, —OP(O)R′O—, —P(O)(N(R′)₂)NR′—, —P(R′)₂═N— or —P(O)R′— where R′ each independently is H, non-fluorinated, partially fluorinated or perfluorinated straight-chain or branched C₁- to C₁₈-alkyl, saturated C₃- to C₇-cycloalkyl, non-substituted or substituted phenyl and X each independently is halogen;
a phosphonium cation, which conforms to the formula (4)
[P(R²)₄]⁺ (4),
where
R² in each case, independently of one another, denotes
H, OR′ or N(R′)₂,
straight-chain or branched alkyl having 1-20 C atoms,
straight-chain or branched alkenyl having 2-20 C atoms and one or more double bonds,
straight-chain or branched alkynyl having 2-20 C atoms and one or more triple bonds,
saturated, partially or fully unsaturated cycloalkyl having 3-7 C atoms, which may be substituted by straight-chain or branched alkyl groups having 1-6 C atoms, where one or two R² may be fully substituted by halogens, in particular —F and/or —Cl, and one or more of the substituents R² may be partially substituted by halogens, in particular —F and/or —Cl, and/or by —OH, —OR′, —CN, —N(R′)₂, —C(O)OH, —C(O)OR′, —C(O)R′, —C(O)N(R′)₂, —SO₂N(R′)₂, —C(O)X, —SO₂OH, —SO₂X, —NO₂, —SR′, —S(O)R′, —SO₂R′ and where one or two non-adjacent carbon atoms in R² which are not in the α-position may be replaced by atoms and/or atom groups selected from the group —O—, —S—, —S(O)—, —SO₂—, —SO₂O—, —C(O)—, —C(O)O—, —N⁺(R′)₂—, —P(O)R′O—, —C(O)NR′—, —SO₂NR′—, —OP(O)R′O—, —P(O)(N(R′)₂)NR′—, —P(R′)₂═N— or —P(O)R′— where R′ each independently is H, non-fluorinated, partially fluorinated or perfluorinated straight-chain or branched C₁- to C₁₈-alkyl, saturated C₃- to C₇-cycloalkyl, non-substituted or substituted phenyl and X each independently is halogen;
a uronium cation, which conforms to the formula (5)
[C(NR³R⁴)(OR⁵)(NR⁶R⁷)]⁺ (5),
where
R³ to R⁷ each, independently of one another, denote
H, where H is excluded for R⁵,
straight-chain or branched alkyl having 1 to 20 C atoms,
straight-chain or branched alkenyl having 2-20 C atoms and one or more double bonds,
straight-chain or branched alkynyl having 2-20 C atoms and one or more triple bonds,
saturated, partially or fully unsaturated cycloalkyl having 3-7 C atoms, which may be substituted by straight-chain or branched alkyl groups having 1-6 C atoms, where one or two of the substituents R³ to R⁷ may be fully substituted by halogens, in particular —F and/or —Cl, and one or more of the substituents R³ to R⁷ may be partially substituted by halogens, in particular —F and/or —Cl, and/or by —OH, —OR′, —N(R′)₂, —CN, —C(O)OH, —C(O)OR′, —C(O)R′, —C(O)N(R′)₂, —SO₂N(R′)₂, —C(O)X, —SO₂OH, —SO₂X, —SR′, —S(O)R′, —SO₂R′, —NO₂ and where one or two non-adjacent carbon atoms in R³ to R⁷ which are not in the α-position may be replaced by atoms and/or atom groups selected from the group —O—, —S—, —S(O)—, —SO₂—, —SO₂O—, —C(O)—, —C(O)O—, —N⁺(R′)₂—, —P(O)R′O—, —C(O)NR′—, —SO₂NR′—, —OP(O)R′O—, —P(O)(N(R′)₂)NR′—, —P(R′)₂═N— or —P(O)R′— where R′ each independently is H, non-fluorinated, partially fluorinated or perfluorinated straight-chain or branched C₁- to C₁₈-alkyl, saturated C₃- to C₇-cycloalkyl, non-substituted or substituted phenyl and X each independently is halogen;
a thiouronium cation, which conforms to the formula (6)
[C(NR³R⁴)(SR⁵)(NR⁶R⁷)]⁺(6),
where
R³ to R⁷ each, independently of one another, denote
H, where H is excluded for R⁵,
straight-chain or branched alkyl having 1 to 20 C atoms,
straight-chain or branched alkenyl having 2-20 C atoms and one or more double bonds,
straight-chain or branched alkynyl having 2-20 C atoms and one or more triple bonds,
saturated, partially or fully unsaturated cycloalkyl having 3-7 C atoms, which may be substituted by straight-chain or branched alkyl groups having 1-6 C atoms, where one or two of the substituents R³ to R⁷ may be fully substituted by halogens, in particular —F and/or —Cl, and one or more of the substituents R³ to R⁷ may be partially substituted by halogens, in particular —F and/or —Cl, and/or by —OH, —OR′, —N(R′)₂, —CN, —C(O)OH, —C(O)OR′, —C(O)R′, —C(O)N(R′)₂, —SO₂N(R′)₂, —C(O)X, —SO₂OH, —SO₂X, —SR′, —S(O)R′, —SO₂R′, —NO₂ and where one or two non-adjacent carbon atoms in R³ to R⁷ which are not in the α-position may be replaced by atoms and/or atom groups selected from the group —O—, —S—, —S(O)—, —SO₂—, —SO₂O—, —C(O)—, —C(O)O—, —N⁺(R′)₂—, —P(O)R′O—, —C(O)NR′—, —SO₂NR′—, —OP(O)R′O—, —P(O)(N(R′)₂)NR′—, —P(R′)₂═N— or —P(O)R′— where R′ each independently is H, non-fluorinated, partially fluorinated or perfluorinated straight-chain or branched C₁- to C₁₈-alkyl, saturated C₃- to C₇-cycloalkyl, non-substituted or substituted phenyl and X each independently is halogen;
a guanidinium cation, which conforms to the formula (7)
[C(NR⁸R⁹)(NR¹⁰R¹¹)(NR¹²R¹³)]⁺ (7),
where
R⁸ to R¹³ each, independently of one another, denote
H, —CN, N(R′)₂, —OR′,
straight-chain or branched alkyl having 1 to 20 C atoms,
straight-chain or branched alkenyl having 2-20 C atoms and one or more double bonds,
straight-chain or branched alkynyl having 2-20 C atoms and one or more triple bonds,
saturated, partially or fully unsaturated cycloalkyl having 3-7 C atoms, which may be substituted by straight-chain or branched alkyl groups having 1-6 C atoms, where one or two of the substituents R⁸ to R¹³ may be fully substituted by halogens, in particular —F and/or —Cl, and one or more of the substituents R⁸ to R¹³ may be partially substituted by halogens, in particular —F and/or —Cl, and/or by —OH, —OR′, —N(R′)₂, —CN, —C(O)OH, —C(O)OR′, —C(O)R′, —C(O)N(R′)₂, —SO₂N(R′)₂, —C(O)X, —SO₂OH, —SO₂X, —SR′, —S(O)R′, —SO₂R′, —NO₂ and where one or two non-adjacent carbon atoms in R⁸ to R¹³ which are not in the α-position may be replaced by atoms and/or atom groups selected from the group —O—, —S—, —S(O)—, —SO₂—, —SO₂O—, —C(O)—, —C(O)O—, —N⁺(R′)₂—, —P(O)R′O—, —C(O)NR′—, —SO₂NR′—, —OP(O)R′O—, —P(O)(N(R′)₂)NR′—, —P(R′)₂═N— or —P(O)R′—, where R′ each independently is H, non-fluorinated, partially fluorinated or perfluorinated straight-chain or branched C₁- to C₁₈-alkyl, saturated C₃- to C₇-cycloalkyl, non-substituted or substituted phenyl and X each independently is halogen;
a heterocyclic cation which conforms to the formula (8)
[HetN]^{z+} (8)
where
HetN^{z+} denotes a heterocyclic cation selected from the group 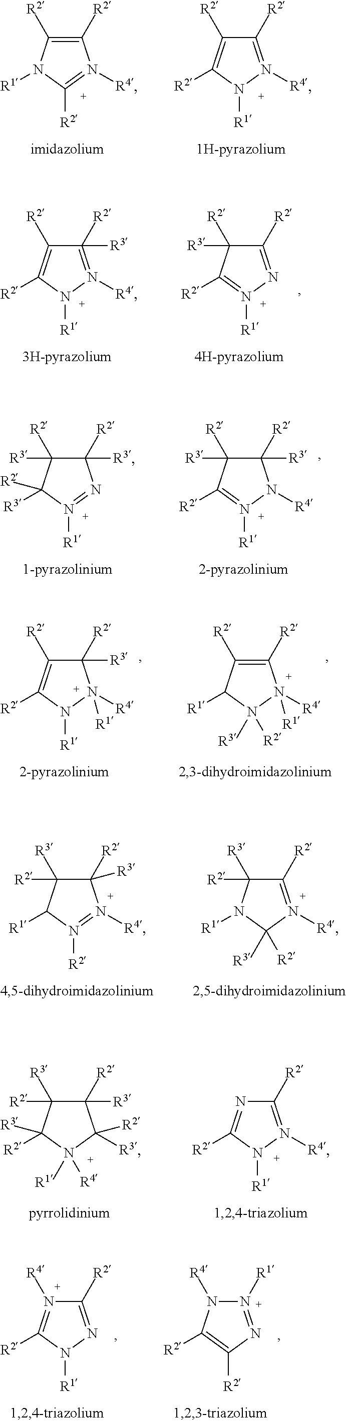 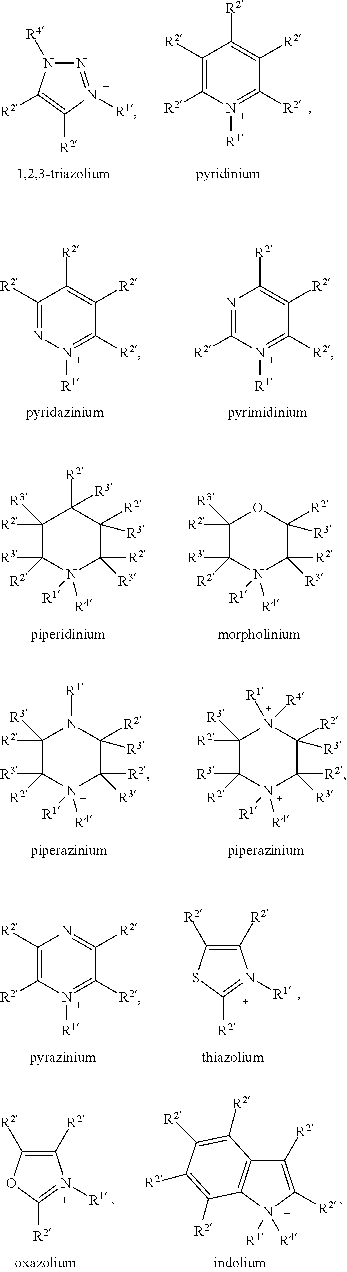 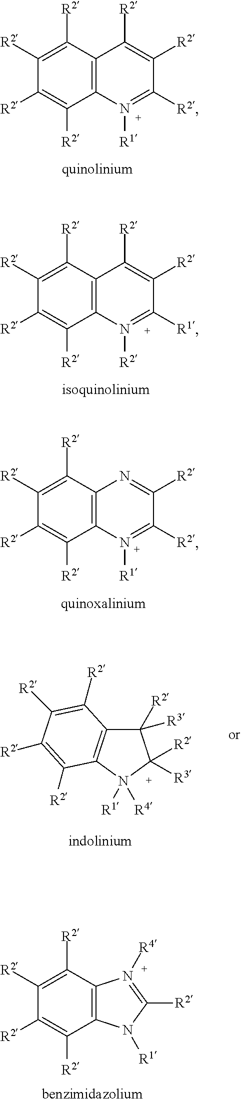
where the substituents
R^{1′} to R^{4′} each, independently of one another, denote
H, with the proviso that R^{1′} and R^{4′} together are not H in one cation,
straight-chain or branched alkyl having 1-20 C atoms,
straight-chain or branched alkenyl having 2-20 C atoms and one or more double bonds,
straight-chain or branched alkynyl having 2-20 C atoms and one or more triple bonds,
saturated, partially or fully unsaturated cycloalkyl having 3-7 C atoms, which may be substituted by straight-chain or branched alkyl groups having 1-6 C atoms, saturated, partially or fully unsaturated heteroaryl, heteroaryl-C₁-C₆-alkyl or aryl-C₁-C₆-alkyl and
R^{2′} denote additionally F, Cl, Br, I, —CN, —OR′, —N(R′)₂, —P(O)(R′)₂, —P(O)(OR′)₂, —P(O)(N(R′)₂)₂, —C(O)R′, —C(O)OR′, —C(O)X, —C(O)N(R′)₂, —SO₂N(R′)₂, —SO₂OH, —SO₂X, —SR′, —S(O)R′, —SO₂R′ and/or NO₂, with the proviso that R^{1′}, R^{3′}, R^{4′} are in this case independently of each other H and/or a straight-chain or branched alkyl having 1-20 C atoms, straight-chain or branched alkenyl having 2-20 C atoms and one or more double bonds,
where the substituents R^{1′}, R^{2′}, R^{3′} and/or R^{4′} together may also form a ring system,
where one to three substituents R^{1′} to R^{4′} may be fully substituted by halogens, in particular —F and/or —Cl, and one or more substituents R^{1′} to R^{4′} may be partially substituted by halogens, in particular —F and/or —Cl, and/or by —OH, —OR′, N(R′)₂, —CN, —C(O)OH, —C(O)OR′, —C(O)R′, —C(O)N(R′)₂, —SO₂N(R′)₂, —C(O)X, —SO₂OH, —SO₂X, —SR′, —S(O)R′, —SO₂R′, —NO₂, but where R^{1′} and R^{4′} cannot simultaneously be fully substituted by halogens and where, in the substituents R^{1′} to R^{4′}, one or two non-adjacent carbon atoms which are not bonded to the heteroatom may be replaced by atoms and/or atom groups selected from the —O—, —S—, —S(O)—, —SO₂—, —SO₂O—, —C(O)—, —C(O)O—, —N⁺(R′)₂—, —P(O)R′O—, —C(O)NR′—, —SO₂NR′—, —OP(O)R′O—, —P(O)(N(R′)₂)NR′—, —P(R′)₂═N— or —P(O)R′—,
where R′ each independently is H, non-fluorinated, partially fluorinated or perfluorinated straight-chain or branched C₁- to C₁₈-alkyl, saturated C₃- to C₇-cycloalkyl, non-substituted or substituted phenyl and X each independently is halogen
and halogen is F, Cl, Br or I.

3. The electrolyte formulation according to claim 1 in which the inorganic cation Kt^{z+} of the compound of formula (I) denotes a metal cation or NO⁺.

4. The electrolyte formulation according to claim 1 comprising the anion dihydridodicyanoborate in molar concentrations from 0.1 to 5.5 M.

5. An electrochemical and/or optoelectronic device comprising an electrolyte formulation according to claim 1 which is a photovoltaic cell, a light emitting device, an electrochromic or photo-electrochromic device, an electrochemical sensor and/or biosensor.

6. The device according to claim 5 which is a dye or quantum dot sensitized solar cell.

7. The device according to claim 5 which is a dye sensitized solar cell.

8. The device according to claim 7 comprising a semiconductor, the electrolyte formulation and a counter electrode.

9. Use of the electrolyte formulation according to claim 1 in an electrochemical and/or optoelectronic device which is a photovoltaic cell, a light emitting device, an electrochromic or photo-electrochromic device, an electrochemical sensor and/or biosensor.

10. Use according to claim 9 in which the device is a dye sensitized solar cell.
